(19) United States
(12) Patent Application Publication
(10) Pub. No.: US 2025/0159499 A1
(43) Pub. Date: May 15, 2025

(54) OPTIMIZATION OF THE CONFIGURATION OF A MOBILE COMMUNICATIONS NETWORK

(71) Applicant: Telecom Italia S.p.A., Milano (IT)

(72) Inventors: Lorenzo Mario AMOROSA, Bologna (IT); Giorgio GHINAMO, Torino (IT); Davide MICHELI, Torino (IT); Giuliano MURATORE, Rocca Priora, Roma (IT); Marco SKOCAJ, Bologna (IT); Roberto VERDONE, Bologna (IT); Flavio ZABINI, San Giovanni in Persiceto, BO (IT)

(73) Assignee: Telecom Italia S.p.A., Milano (IT)

(21) Appl. No.: 18/838,346

(22) PCT Filed: Feb. 10, 2023
(86) PCT No.: PCT/EP2023/053340

§ 371 Date: Aug. 14, 2024

(30) Foreign Application Priority Data
Feb. 15, 2022 (IT) 102022000002738

(51) Int. Cl. H04W 24/02; H04W 24/06

(52) U.S. Cl. CPC H04W 24/02; H04W 24/06

(57) ABSTRACT

A method for adjusting network cell parameters in a self-organizing cellular mobile network using a data processing system. The method involves creating an Environment that simulates the network based on radio measurement data, network performance data, and electromagnetic field simulation. A Deep Reinforcement Learning (DRL) Agent interacts with this Environment to simulate the effects of parameter changes on network performance. The Environment calculates and returns a Reward to the DRL Agent, which is used to train the Agent and estimate Q-values. The DRL Agent selects actions based on a policy that balances greedy actions, random actions, and constrained random actions. If the DRL Agent violates a predetermined constraint, the Environment returns a penalizing Reward.

### TECHNICAL FIELD

The present disclosure relates to the field of mobile communications networks. In particular, the present disclosure relates to the optimization of mobile communications networks, particularly but not limitatively 5G or future generations networks. A method, and a system for implementing the method, for optimizing mobile communications networks is disclosed.

### TECHNICAL BACKGROUND

In the field of cellular mobile communications networks (in the following also referred to as “cellular networks” or “mobile networks” or “mobile communications networks”, for the sake of conciseness), like fourth generation (“4G”) and fifth generation (“5G”) networks, “Coverage and Capacity Optimization” (“CCO” in short) has the aim of providing the best configuration for network cells able of maximizing both network coverage and network capacity to mobile network users on the field. This can be achieved with modifications to adjustable, tunable parameters of the network cells. Examples of cells' tunable parameters are transmission power, electrical tilt and azimuth of the antennas, and any other available parameter affecting radiation diagram and power spatial distribution, including but not limiting parameters controlling radiation patterns for active antennas, for beamforming techniques (typical of 5G networks).

“Self Organizing Networks” (“SON” in short) is an automation technology paradigm able to perform the actions of planning and optimization (but also configuration and management) of cellular mobile communications networks, particularly 4G networks, 5G networks—where the impact of SON algorithms such as the CCO is expected to be particularly significant—and networks of the next generations, using a more flexible approach for continuous improvement of performance even in closed-loop configuration.

The SON paradigm aims to make the planning and optimization phases of a cellular mobile communications network (from the fourth generation onwards) easier and faster. Thanks to SON algorithms such as CCO—operating on cells' tunable parameters such as cell's antenna(s) electrical tilt, cell's transmission power and cell's antenna(s) azimuth, other parameters affecting radiation diagram and power spatial distribution, including but not limiting parameters controlling radiation patterns for active antennas, for beamforming techniques, just to mention a few—it is possible to improve the performance, for example in terms of user throughput and/or carried traffic, also through continuous closed-loop optimization.

Belonging to the SON paradigm are also the so-called “self-healing algorithms”, which act when some devices of the mobile communications network go into temporary fault, and “self-configuration algorithms”, adopted to automatically perform the configuration of new devices added to the network.

Basically, there are two fundamental types of SON: the “Centralized SON” (“C-SON”) type which works on large numbers of cells with a centralized logic, and the “Distributed SON” (“D-SON”) type which, on the other hand, operates at the level of the single network node (e.g., single cell) for local optimization purposes.

The CCO problem for a cellular mobile communications network is typically hard. As mentioned above, there are several cell's parameters that may be tuned to improve Coverage and Capacity on the field. Considering, for the sake of simplicity, only antennas' electrical tilt configuration (a similar reasoning also applies to other cells' tunable parameters such as power transmission, antenna azimuth, parameters affecting radiation diagram and power spatial distribution, including but not limiting parameters controlling radiation patterns for active antennas for beamforming techniques, or a combination thereof), and focusing on a delimited geographic area where the antennas' electrical tilt of a number C of network cells can be tuned, each of them with a number T of discretized electrical tilts that can be selected, the possible solution space is:

$${\vert tilts \vert}^{\vert cells \vert} = {\vert T \vert}^{\vert C \vert}$$

This constitutes an NP-hard combinatorial optimization problem where the number of admissible configurations grows exponentially with the number C of cells under consideration. For the sake of simplicity, assuming that all the network cells have the same number T=5 of possible electrical tilts (more generally, each network cell might have a different number of permissible electrical tilts):
13 cells with 5 tilts means 5³≅1.2 billions of possible configurations, and
16 cells with 5 tilt means 51⁶≅152 billions of possible configurations.

Such solution space is prohibitively too large to be systematically explored by any optimization algorithm, and therefore there is the need for a smart and economical approach capable of finding an optimal (or quasi-optimal) solution by only exploring a subset of all solutions in the space.

### SUMMARY

The Applicant has tackled the problem of devising an efficient method and system for CCO in a SON mobile communications network, particularly but not limitatively a 5G network.

The solution disclosed in this document relates to a data-driven Deep Reinforcement Learning (DRL) method and system for CCO, specifically to a Minimization of Drive Tests (MDT)-driven DRL method and system. MDT data from the mobile communications network are used, together with network performance indicators and results of electromagnetic simulations, to define a simulated network environment for the training of a DRL, Deep Q-Networks (DQN) agent.

MDT data are useful to retrieve different kinds of information. In particular, MDT data are exploited to get Radio Frequency (RF) signal levels of the network cells distributed over the territory, and the users and traffic density distribution over the pixels of the geographic territory (area of interest) under consideration.

The RF signal levels are exploited to calculate the SINR, together with traffic information aggregated per cell.

The traffic density distribution is used to estimate the weight of each territory pixel.

According to an aspect thereof, the solution disclosed in this document is directed to a method, implemented by a data processing system, of adjusting modifiable parameters of network cells of a deployed self-organizing cellular mobile communications network comprising network cells covering a geographic area of interest, said network cells comprising configurable cells having modifiable parameters, and non-configurable cells in the neighborhood of the configurable cells.

The method comprises:
providing an Environment configured for simulating said mobile communications network, wherein the Environment is configured to simulate said mobile communications network based upon:
radio measurement data, comprising radio measurements with associated geolocalization and time stamp, performed by user equipment connected to the mobile communications network and received from the deployed mobile communications network;
network performance data provided by the deployed mobile communications network, and
simulation data obtained by an electromagnetic field propagation simulator and corresponding to different possible configurations of the values of the modifiable parameters of the configurable cells.

The method further includes:
providing a DRL Agent configured for interacting with the Environment by acting on the Environment to cause the Environment to simulate effects, in terms of network performance, of modifications of the values of the modifiable parameters of the configurable cells, the Environment being configured for calculating and returning to the DRL Agent a Reward indicative of the goodness of the actions selected by the DRL Agent and undertaken on the Environment, the Reward being exploited by the DRL Agent for training and estimating Q-values.

The DRL Agent, during training time, in selecting an action to be undertaken on the Environment among all the possible actions, adopts an action selection policy that:
with a certain first probability selects a greedy action based on the estimated Q-values,
with a second probability selects:
   either a random action selected randomly among all the possible actions, with a third probability, or
   with a fourth probability, a random action among a set of actions that satisfy a predetermined action constraint.

In case the DRL Agent selects, and causes the Environment to simulate the effects of, an action that violates said predetermined constraint, the Environment is configured to return to the DRL Agent a penalizing Reward.

Said radio measurement data comprising radio measurements with associated geolocalization and time stamp may be Minimization of Drive Test, MDT, data.

Said predetermined action constraint may be a constraint for not attempting to modify a modifiable parameter of a configurable cell already subjected, in past actions selected by the DRL Agent, to a modification of its modifiable parameters.

Said first and second probabilities can be such that their sum is 1, and said third and fourth probabilities can be such that their sum is 1.

The actions undertaken by the DRL Agent on the Environment can be grouped in a sequence of actions defining an Episode. In embodiments of the solution here disclosed, the value of the third probability may decrease during an Episode, starting from an initial value for the first action of the Episode and decreasing to a final value for the last action of the Episode.

In embodiments of the solution here disclosed, the second probability may increase during an Episode, starting from an initial value of the second probability for the first action of the Episode and increasing to a final value of the second probability for the last action of an Episode.

Multiple Episodes may follow one another. In embodiments of the solution here disclosed, the value or the values of the second probability can vary as the number of Episodes increases, particularly, the value or the values of the second probability may decrease as the number of the Episodes increases.

Each action selected by the DRL Agent may be an action that attempts to modify the value of one single configurable parameter of one single configurable cell of the configurable cells.

The Environment may be configured to command the DRL Agent to stop an ongoing sequence of actions after a predetermined number of actions selected by the DRL Agent that violates said predetermined constraint.

The Environment may be configured for analyzing and aggregating said radio measurement data based on geolocation information included in the radio measurement data, in territory pixels corresponding to the territory pixels of the simulation data.

The Environment may be configured for calculating, for each territory pixel and based on the MDT data:
a pixel RSRP being an average of the RSRPs included in the radio measurement data corresponding to such pixel;
a pixel SINR, and
a pixel weight providing an indication of an average number of active UEs or RRC connected UEs, in such pixel.

Said pixel SINR may be calculated:
either as a ratio of useful radio signal power to interfering radio signals powers in the considered pixel,
or based on an aggregated RSRQ at the pixel level and on percentage of occupied radio resources.

The Environment may be configured to calculate, for every pixel:
a RSRP difference between the calculated pixel RSRP, calculated based on the MDT data, and the RSRP resulting from the simulation data, and
a SINR difference between the calculated pixel SINR, calculated based on the MDT data, and the SINR resulting from the simulation data.

The Environment, when the DRL Agent undertakes an action on it, may be configured to, for every pixel:
taking the RSRP and the SINR from the simulation data that correspond to the new configuration of the configurable cells indicated in the actions requested by the DRL Agent, and
applying to the RSRP and SINR taken from the simulation data said RSRP difference and said SINR difference, respectively, to obtain estimated RSRP and estimated SINR for the new configuration of the configurable cells.

The Environment may be configured to:
re-assing territory pixels to respective best-server network cells based on the estimated RSRP for the new configuration of the configurable cells.

The Environment may be configured to:
redistribute UEs to the network cells based on the re-assignment of the territory pixels to the respective best-server network cells, and
calculate numbers of UEs per network cell for the new configuration.

Said Reward indicative of the goodness of the actions selected by the DRL Agent may be indicative of an estimated overall performance of a network configuration resulting from a simulation of modifications of the values of the modifiable parameters of the configurable network cells by the Environment, wherein the Environment is configured to calculate said Reward by calculating an estimation of an overall throughput as a weighted average of estimated average user throughputs per network cell, where the weights in the weighted average are based on said calculated numbers of UEs per network cell.

The Environment may be configured to calculate said estimated average user throughputs per network cell by calculating an average spectral efficiency by network cell and an average number of communication resources available per user at the cell level.

The Environment may be configured to calculate said average spectral efficiency by network cell as a weighted average of a spectral efficiency by pixel, with weights corresponding to the weights of the pixels calculated by the Environment (305).

The Environment may be configured to calculate said spectral efficiency by pixel based on a mapping of the estimated SINR values to values of Channel Quality Indicator.

Said mapping can be established on the basis of an analysis of the radio measurement data, particularly the MDT data, related to said geographic area of interest.

The Environment may be configured to calculate said Reward by reducing said weighted average of estimated average user throughput per network cell proportionally to a number of beams used by the network cells' antennas.

The Environment may be configured to calculate said Reward by applying a reward penalty in case the actions selected by the DRL Agent and undertaken on the Environment results in a violation of predetermined network coverage area constraints.

According to another aspect thereof, the solution disclosed in the present document relates to a data processing system configured for automatically adjusting modifiable parameters of network cells of a self-organizing cellular mobile communications network, the system comprising:
a self-organizing network module comprising a capacity and coverage optimization module,

wherein the capacity and coverage optimization module is configured to execute the method of the preceding aspect of the solution here disclosed.

By providing a simulated network environment and making the DQN Agent directly interact with it for the Agent's training, instead of having the DQN Agent directly interact with the physical mobile network deployed on field, is advantageous to avoid potentially degrading actions performed during the exploration phase of the Agent's training. Moreover, with an Agent interacting directly with the physical network, it would be practically infeasible to collect MDT measurements for every possible combination of configurations that the Agent explores at training time. Thanks to the simulated network environment, the training of the DQN Agent takes place “off-line” and can take advantage of realistic data like MDT measurements and network performance indicators.

### BRIEF DESCRIPTION OF THE DRAWINGS

Features and advantages of the solution here disclosed, including those mentioned in the foregoing, will appear more clearly by reading the following detailed description of exemplary and non-limitative embodiments. For a better intelligibility, the following description should be read making reference to the annexed drawings, wherein:

FIG. 1 is a pictorial view of an exemplary geographic area of interest covered by cells of a SON mobile communications network whose parameters are tunable for CCO purposes;

FIG. 2 schematically depicts an exemplary cell parameter that can be tuned for CCO purposes, particularly the electrical tilt of a cell's antenna;

FIG. 3 is an overview, at the level of logical modules, of a system for CCO according to an embodiment of the solution disclosed herein, comprising a simulated network environment and a Deep Reinforcement Learning Agent;

FIG. 4 schematically depicts, in terms of logical/functional modules, the simulated network environment;

FIG. 5 is a flowchart highlighting some of the operations performed by the simulated network environment;

FIG. 6 is an exemplary antenna radiation diagram on the horizontal plane;

FIG. 7 schematically depicts an exemplary observation space of the Deep Reinforcement Learning Agent, for a generic pixel of the geographic area of interest;

FIG. 8 depicts the architecture of the Deep Reinforcement Learning Agent, in terms of logical/functional modules;

FIG. 9 schematizes an exemplary deep-tree Markov Decision Process in which the mobile communication network optimization problem is reformulated, in accordance with the solution disclosed herein;

FIG. 10 schematically depicts an architecture for the training of the Deep Reinforcement Learning Agent;

FIG. 11 is a diagram showing a variation of the value of a probability ε (in ordinate), with the increase in the number of Episodes (in abscissa), for defining an exploration policy of the Deep Reinforcement Learning Agent, in an embodiment of the solution disclosed herein;

FIG. 12 is a diagram showing a variation of the values of a number of probabilities 8 (in ordinate), with the increase in the number of Episodes (in abscissa), for defining an exploration policy of the Deep Reinforcement Learning Agent, in another embodiment of the solution disclosed herein;

FIG. 13 is a diagram showing different values of a further probability q (in ordinate) for different steps of the Episodes (in abscissa), for defining an exploration policy of the Deep Reinforcement Learning Agent, in an embodiment of the solution disclosed herein;

FIG. 14 shows a structure of a Deep Neural Network of the DRL Agent, in an embodiment of the solution disclosed herein;

FIG. 15 shows an alternative structure of a Deep Neural Network of the DRL Agent, in an embodiment of the solution disclosed herein;

FIG. 16 is a diagram (with number of steps of an Episode, in abscissa, vs. calculated Reward in ordinate) comparatively showing the performance of a customized collection policy according to the solution here disclosed vs. a Best First Search algorithm, and

FIG. 17 is a diagram reporting a MDT data analysis conducted on a territory of reference to derive an empirical law for the mapping between CQI (in abscissa) and SINR (in ordinate).

### DETAILED DESCRIPTION OF EXEMPLARY EMBODIMENTS

The disclosure in this document proposes a method and a related system for CCO of a cellular mobile communications network (in short, “mobile network”), particularly a 5G (or future generations mobile communications networks adopting the SON paradigm).

The disclosed method and system can be applied to improve network performance in a geographic area of interest covered by the mobile network.

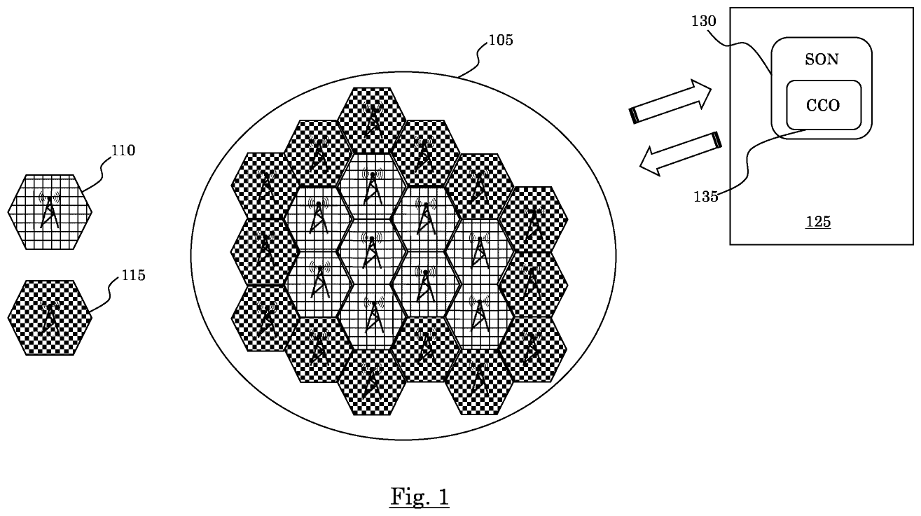

Making reference to FIG. 1, a specific geographic area 105 (being a portion of the territory covered by the mobile network) is selected for CCO purposes. The geographic area 105 (from now on also referred to as “geographic area of interest”) can be chosen taking into consideration several “Key Performance Indicators” (“KPIs”, that are measures of network performance at the network service level, providing the mobile operator with data indicative of the performance of the mobile network), which the mobile network operator wishes to improve (by tuning cells' adjustable parameters like electrical antenna tilts and beamforming parameters) to provide better services to mobile network users. Such KPIs may include, but are not limited to:
the number of “overtarget cells” (number that should be minimized, because overtarget cells are network cells experiencing a high traffic load that causes a reduction in user throughput),
the total cell traffic that exceeds an overtarget threshold, for example set by regulatory standards (that should be minimized for similar reasons),
the throughput guaranteed by the cells (to be maximized in order to improve the interferential conditions and therefore the total capacity of the cell/network)
the throughput offered to mobile users (to be maximized in order to improve the quality of service/quality of experience of the mobile network users),
the number of cells experiencing poor Signal-to-Interference-plus-Noise Ratio (SINR) conditions.

Once the geographic area of interest 105 is defined, the mobile network cells covering such area can be conveniently divided into two sets, as schematized in FIG. 1, for the formulation of the CCO problem:
1. a set of “Target cells” 110 to be optimized (by changing—tuning, adjusting—one or more of their configurable parameters, e.g., antenna(s) electrical tilt, antenna(s) azimuth, transmission power, beamforming parameters);
2. a set of “Adjacent cells” 115, in the neighbourhood of and adjacent to the Target cells 110, whose configuration parameters cannot be, or are not to be modified but that are nonetheless affected (due to radio signal interference) by the Target cells 110 and can affect with them (i.e., interfere with the radio signals thereof); these Adjacent cells 115 are taken into consideration to consider boundary effects of the actions attempted for CCO.

Reference numeral 125 denotes a mobile network monitor and configurator system, including a data processing system comprising a SON module 130 and, within the SON module 130, a CCO module 135. The CCO module 135 is a module configured to perform a CCO of the mobile network. The SON module 130 is a module configured to dynamically configure (e.g., modify a current configuration of cells' parameters deployed on the field) the network cells, particularly based on the results of an optimization procedure performed by the CCO module, as will be described in detail later on.

The mobile network optimization procedure is performed by the CCO module 135 on the (cells of the) selected area of interest 105, and is directed to identify a better (“optimized”) configuration of the tunable parameters of the Target cells 110 in the area of interest 105. Once the optimization procedure is completed and a better (“optimized”) cells' parameters configuration is found, the SON module 130 deploys changes to the network configuration on field (modifying the values of the tunable parameters of the Target cells 110, through SON Application Programming Interfaces—“APIs”—that allow remote software configuration of cells' parameters, e.g., antennas' electrical tilts, beamforming parameters etc.).

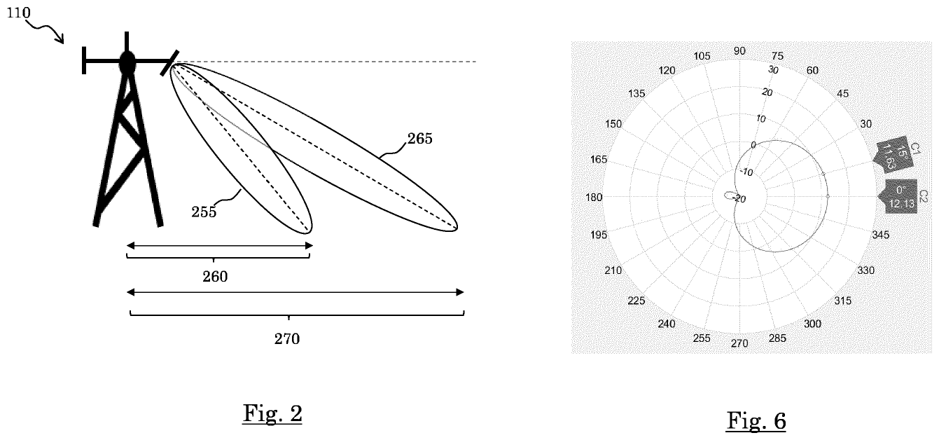

Considering, as an example of configurable parameter of the Target cells 110, the electrical tilts of the Target cells' antennas, FIG. 2 helps understanding that by changing the tilt of a cell's antenna, network performance, such as capacity, coverage and interference, are affected. In particular, a greater tilt 255 reduces the area covered by the network cell's signals (“service area”) 260, increases the cell capacity dedicated to each user falling within the service area, and reduces the interference between the cell and neighbouring cells; conversely, a lower antenna tilt 265 increases the cell's service area 270, but it may reduce the capacity dedicated to each user, and can increase the interference with neighbouring cells. Analogous considerations apply, mutatis mutandis, for other Target cells' configurable parameters, like beamforming parameters.

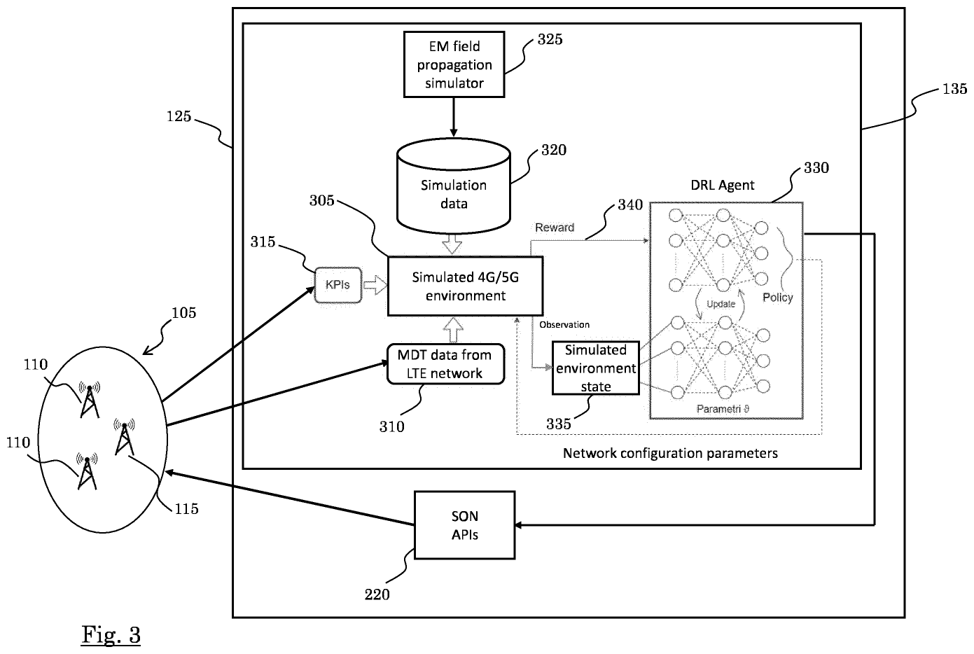

FIG. 3 is an overview, at the level of logical modules, of a network optimization system (CCO module 135) according to an embodiment of the solution disclosed herein.

The network optimization method and system here proposed are based on a Reinforcement Learning (RL) approach, particularly a Deep RL. The concepts of RL and Deep RL are well known to those skilled in the art of Machine Learning (ML) and will not be explained in detail here. In essence, Deep RL is a subfield of ML that combines RL and deep learning. As also known to the skilled persons, fundamental elements in RL and Deep RL are the “Agent”, or Deep Learning Agent in Deep RL, and the “Environment”. The Deep Learning Agent is an autonomous or semi-autonomous Artificial Intelligence (AI)-driven system that uses deep learning to perform and improve at its tasks. The “Environment” is the Agent's world in which the Agent lives and with which the Agent interacts. In the network optimization method and system here proposed, the Agent can interact with the Environment by performing some actions on the Environment, and the actions performed by the Agent modify the Environment and the successive states of the Environment.

The Environment of the network optimization system here disclosed simulates the mobile network to be optimized, particularly a 4G/5G mobile network, and is hereinafter called simulated network environment 305. The simulated network environment 305 receives as inputs three types of input data: Minimization of Drive Test (MDT) data 310; mobile network traffic Key Performance Indicators (KPIs) data 315, and results of electromagnetic field propagation simulations (advantageously stored in a repository) 320. The purpose of the simulated network environment 305 is to accurately represent the effects that the reconfiguration of a cell's parameter (e.g., eNodeBs' antenna tilts), which corresponds to an action selected by the Agent, has on network performance.

The MDT data 310 and the KPI data 315 come from the (mobile network deployed on the) field. In particular, the KPIs measure network performance at the mobile network level. The MDT data 310 are essentially radio measurements performed by User Equipment (UEs) on the field and reported to the mobile network. MDT is a standardized mechanism introduced in 3GPP Release 10 to provide mobile network operators with network performance optimization tools in a cost-efficient manner. The main characteristics of MDT are:
the mobile network operator is able to configure the measurements to be performed by the UEs independently from the network configuration;
the UEs report measurement logs at the occurrence of particular events (e.g., radio link failure);
the mobile network operator has the possibility to configure the logging in geographical areas;
the measurements performed and reported by the UEs are linked with information which makes it possible for the mobile network operator to derive indications about the geographical location (geolocation) of the UEs, and
the measurements reported by the UEs have associated time stamps.

The MDT data 310 can be a collection of MDT samples collected during a measurement campaign, for example relating to a one-day period.

The MDT data 310 include in particular, but not limited to, Reference Signal Received Power (RSRP), Reference Signal Received Quality (RSRQ), Received Signal Code Power (RSCP), Pilot Chip Energy to Interference Power Spectral Density, Data Volume, scheduled IP throughput, packet delay, packet loss rate, Round Trip Time (RTT) and Rx-Tx time difference (RxTx_TimeDiff) measurements.

The MDT data 310 also include anonymous temporary identifiers identifying a UE's connection with the mobile network, i.e., anonymous data indicative of the connections, at the Radio Resource Control (RRC) level, between the UEs and the radio base stations of the mobile network. Such anonymous data are included in every MDT data sample in a field named “Call Identifier” or “Call_ID”, whose value is assigned by the base station during the collection of the MDT data and remains the same for the duration of a connection between the UE and the base station of the mobile network. Different values in the fields Call_ID may relate to different UEs connecting to the mobile network or to a same UE that disconnects from and then re-connects to the mobile network, e.g., for distinct calls. These data are exploited by the simulated network environment for enumerating connections between the UEs and the mobile network at the RRC (signaling) level.

The MDT data reported by the UEs may also comprise layer information, i.e., information about frequency layers (or frequency bands, such as 800 MHz, 1800 MHz, 2600 MHz) through which the UEs may perform data transmission/reception in the respective serving network cell.

By using the MDT functionality, the measurements reported by the UEs are advantageously combined with UE geolocation information. UEs geolocation information may for example be provided by the UEs (e.g., by exploiting GPS and/or GNSS/A-GNSS functionalities thereof) and/or computed by the mobile network (e.g., by the core network) based on the radio measurements received from the UEs. Examples of geolocation information computed by the mobile network include, but are not limited to, ranging measurements based on localization signals emitted by any properly configured cellular communication equipment, and/or triangulations on signals of the cellular network.

In particular, the following quantities available in MDT samples to build the observation space (MDT observation space) for the Agent:
UE's measured RSRP from the serving primary cell;
UE's measured RSRP from a number (e.g., up to 8) adjacent non serving cells;
UE's measured RSRQ from the serving primary cell, and
anonymous temporary ID identifying a UE's RRC connection (Call ID).

The KPI data 315 include in particular traffic KPIs, gathered with a cell-level spatial granularity:
average active number of UEs per Time Transmission Interval, and
and average cell load p.

The results of electromagnetic field propagation simulations (stored in a repository) 320 are obtained by running (for every one of the different possible configurations of the Target cells 110) an electromagnetic field propagation simulator 325, of the type simulating the propagation of radio signals through a territory taking into account data describing the territory, like natural orography, presence of human artefacts—buildings and so on—, presence of trees etc. Such electromagnetic field propagation simulators are often used by mobile network operators during the planning phase of a mobile communications network. An exemplary electromagnetic field propagation simulation tool is described in EP1329120B1, in the name of the same Applicant hereto.

The simulated network environment 305 has the purpose of simulating the effects, on the mobile network deployed on the field, of the change of the Target cells' 110 configuration parameters (e.g., the antennas' electrical tilts or the beamforming parameters of the Target cells 110). The simulated network environment 305 processes the data received in input (MDT data 310, KPI data 315, results of electromagnetic field propagation simulations—stored in a repository—320), as described in detail later on.

The simulated network environment 305 interfaces with a Deep RL Agent (DRL Agent) 330, described in detail later on. The DRL Agent 330 observes the simulated network environment 305 to derive states 335 thereof. The DRL Agent performs actions on the simulated network environment 305, by causing the latter to change configuration parameters of the network simulated by the simulated network environment 305 (e.g., parameters that in the simulated network environment 305 correspond to the antennas' electrical tilts and/or to beamforming parameters of the Target cells 110). As a consequence of the actions performed thereupon by the DRL Agent 330, the simulated network environment 305 changes its state and provides to the DRL Agent 330 a “Reward” 340 of the performed action (which serves to the DRL Agent 330 as an indication of the effects of the action it took on the simulated network environment 305).

The purpose of the DRL Agent 330 is to learn to take actions directed to maximize a future cumulative reward at the end of an “Episode”, to eventually learn which actions would lead to a maximized cumulative future reward based on its environment observation. As known to those skilled in art of ML, an Episode is a sequence of consecutive states of the Environment, actions performed by the Agent on the Environment and corresponding Rewards returned by the Environment to the Agent, till a terminal state is reached (in a game analogy, the end of a game like a game of Chess). Rewards are calculated by applying a Reward function. The future cumulative Reward is a sum of the Rewards calculated at each step of the Episode.

As an example, the future cumulative Reward R, can be calculated as:

$${R}_{c} = {\sum }_{i = t}^{\# s} {γ}^{i - t} R ( {s}_{i} , {s}_{i + 1} )$$

where #s indicates the number of steps in the considered Episode, γ is a discount factor for future rewards and R(sᵢ,sᵢ₊₁) is the immediate reward obtained after the agent's policy selects action aᵢ based on state sᵢ. The reward at time step after selecting action maps all network performance tradeoffs in one scalar value. Since each step corresponds to optimizing a particular cell among the ones in the considered cluster, and all cells share the same importance, the discount factor γ is set equal to 1.

In the method and system here disclosed, the DRL Agent 330 is configured to implement a “Value-based” RL algorithm: the DRL Agent 330 selects the actions to be taken according to a maximization of a “Q-value”. Since the Q-values are not initially known, during the training of the Agent the Q-values are estimated. In the training phase, by exploring a tree of the possible actions, the estimation of the Q-values is refined and made more and more accurate. The purpose of the DRL Agent 330 is thus to find a function Q(s,a) (s=state of the Environment, a=action taken on the Environment) able to estimate the Q-values with the use of a Deep Neural Network (DNN).

The simulated network environment 305 and the DRL Agent 330 will be now described in detail starting with the simulated network environment 305.

### Simulated Network Environment 305

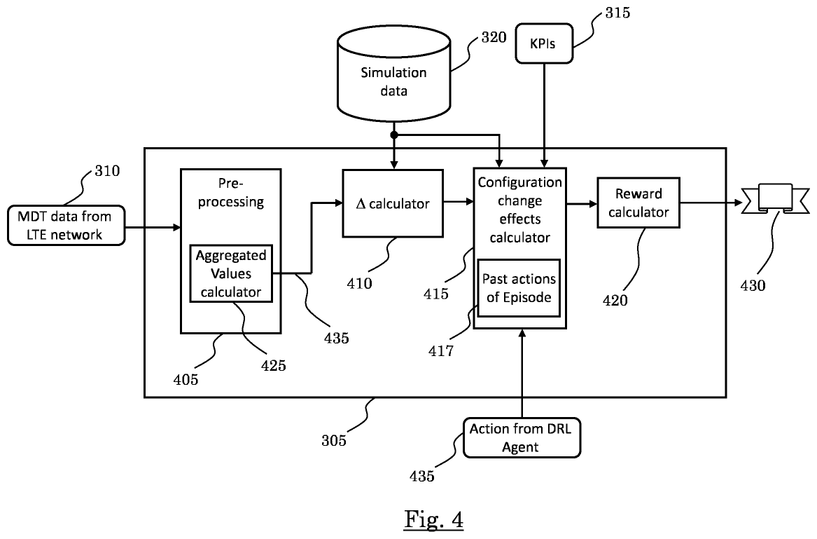

FIG. 4 gives an overview, at the level of functional/logical modules, of some modules of the simulated network environment 305, in an embodiment of the solution here disclosed. The logical modules of the simulated network environment 305 comprise: a Pre-processing module 405; a Δ calculator module 410; a Configuration change effects calculator module 415, and a Reward calculator module 420. The modules of the simulated network environment 305 will be now described.

### Simulated Network Environment 305: Pre-Processing Module 405

The Pre-processing module 405 is configured so that, in operation, it collects the MDT data 310 reported from the field by UEs located in the geographical area of interest 105 (MDT data samples). As mentioned in the foregoing, the area of interest 105 includes a certain number of Target cells 110 and a certain number of Adjacent cells 115. Both the Target cells 110 and the Adjacent cells 115 are considered in the simulated network environment 305 (the Adjacent cells 115 are considered in order to evaluate the effects of changes in the configuration parameters of the Target cells 105 on the Adjacent cells 115).

The pre-processing module 405 is configured so that, in operation, it filters the collected MDT data 310 (which, as mentioned in the foregoing, come with associated time stamps) according to a desired time band (time band of reference) of a generic day (e.g., a day is subdivided in eight time bands of four hours each; one time band can for example be from 14:00 hours to 18:00 hours. However, the time bands in which one day is subdivided are not necessarily of equal duration: for example, during night time, or when it is expected that the level of network traffic is lower, wider time bands can be defined). A possible criterion for defining the time bands is that in a certain time band an essentially constant (“quasi-static”) behaviour in terms of number of connected users is observed (relying for example on the traffic KPIs as connected users at the RRC level).

The pre-processing module 405 is also configured so that, in operation, it aggregates the collected MDT data 310 (which, as mentioned in the foregoing, are geolocalized), filtered by the desired time band as described above, in MDT data pixels, i.e., elementary portions of the geographical area of interest 105, based on the geolocation information (e.g., GPS coordinates) accompanying the MDT data 310 samples. Advantageously, the areas of the MDT data pixels are chosen so as to correspond to the areas of the pixels of the territorial maps used by the electromagnetic field propagation simulator 325 to simulate the propagation of the electromagnetic field, and the MDT data pixels are aligned with the geographical coordinates of the pixels of the territorial maps used by the electromagnetic field propagation simulator 325. In this way, the MDT data pixels are aligned with (overlap) the pixels of the simulation data 320 (simulation data pixels) stored in the repository. The area of interest 105 can include a number of (p*q) pixels; in the exemplary case here described, the area of interest 105 includes a number of (105*106) pixels.

Preferably, the pre-processing module 405 is configured so that, in operation, it discards those MDT data pixels where the number of collected MDT data samples is below a certain minimum threshold (e.g., 25 MDT data samples per pixel), because such MDT data pixels would be statistically unreliable, i.e., not sufficiently reliable for the purposes of the subsequent operations.

In embodiments of the solution here disclosed, the pre-processing module 405 is configured so that, in operation, it discards those MDT data pixels where no measures of the signal level (e.g., the RSRP) of the interfering network cells are available.

The “pixelization” of the MDT data 310 reduces the variance of the single MDT measurements and provide a dimensional-consistent input to the Agent.

The pre-processing module 405 is configured so that, in operation, it calculates, for each MDT data pixel, aggregated values (at the MDT data pixel level) of quantities pixel WEIGHT, pixel RSRP and pixel SINR suitable to characterize the MDT data pixel (Aggregated values calculator module 425 in FIG. 4), for example in the way described herebelow.

### Quantity Pixel WEIGHT:

The pre-processing module 405 is configured so that, in operation, it calculates and assigns a “pixel weight” wᵢ to each MDT data pixel pxᵢ. The weights assigned to the MDT data pixels will be used in the computation of the Reward, as described later on.

The weight wᵢ to be assigned to a generic MDT data pixel pxᵢ can be calculated as the number of different values present in the fields Call_ID of the MDT data samples filtered according to the time band of reference (e.g., the time band from 14:00 to 18:00 hours of the generic day) and within the considered MDT data pixel pxᵢ. As explained in the foregoing, a certain value in the Call_ID field identifies a connection (at the Radio Resource Control—RRC—level) of a UE with the mobile network.

Preferably, the weights assigned to the MDT data pixels are varied at every Episode, i.e., after every predetermined number of consecutive interactions of the DRL Agent 330 with the simulated network environment 305 (as discussed in greater detail later on). For the generic MDT data pixel, the above-mentioned number of different Call IDs is taken as the average value A of a statistical distribution, particularly a Poisson distribution.

Thus, at every Episode, the weight assigned to the considered MDT data pixel is varied according to the Poisson distribution around the average value A. This gives generality to the simulated network environment 305, preventing it from specializing on a particular realization of a stochastic process. In fact, the quality of the data distribution for the training of any AI model is one of the key aspects for avoiding “overfitting” phenomena, i.e., for avoiding the iper-specialization of the algorithm (formally: generation of an error characterized by strong variance) on the data observed during the training time, which is detrimental to the generality and the inference capability on new test-sets never seen before.

### Quantity Pixel RSRP:

For a considered MDT data pixel pxᵢ, a pixel-level aggregated quantity pixel RSRP is calculated as the linear average of the RSRP measurements present in the MDT data samples belonging to the considered MDT data pixel pxᵢ (preferably, the calculated linear average is then translated in dBm).

### Quantity Pixel SINR:

For a considered MDT data pixel pxᵢ, a pixel-level aggregated quantity pixel SINR is calculated (in the context of the present document, SINR is intended to mean the SINR in downlink, measured by the UEs).

Two possible methods for calculating the quantity pixel SINR for a generic MDT data pixel are envisaged.

A first possible method is by calculating a RSRP-based pixel SINR as a ratio of powers:

$$SINR = \frac{{RSRP}_{Pcell} [ mW ]}{{\sum }_{i = 1}^{N} {RSRP}_{, icell} [ mW ] + {N}_{0} [ mW / Hz ] * {B}_{ℜ} [ Hz ]} \qquad ( 1 )$$

where the numerator RSRP_{Pcell}, gives the useful power (RSRP measurement of the best-server network cell, Pcell) in respect of the considered MDT data pixel, and the denominator gives the interference expressed as a sum of interfering cells' RSRP: the power ΣNᵢ₌₁^{N}RSRP_{,icell} of the interfering network cells (RSRP measurements, in the considered MDT data pixel, of the non-serving, interfering network cells, icell with i=1 to N, N being the number of interfering cells; the power spectral density No of a generic receiver device taken as a reference (every UE has a receiver that features a certain noise spectral density describing the receiver performance; for the purpose of simulating the mobile network by means of the simulated network environment 305, a unique power spectral density, for example derived from 3GPP specifications, is taken as a common reference value), and the channel bandwidth BT associated with one Resource Element (RE), given by the definition of RSRP as demodulated average power from the Channel-Reference Signals related to one RE. In case this method is followed, the pre-processing module 405 should be configured so that, in operation, it discards those MDT data pixels pxᵢ where no measurements of the RSRP of the interfering network cells are available.

A second possible method for calculating the quantity pixel SINR (RSRQ-based pixel SINR) starts from the RSRQ and exploits values of counters of the average percentage ρ of occupation of the Physical Resource Blocks (PRBs) of the serving cell of the mobile network (i.e., counter values indicating how many network resources—PRB—of the serving network cell are in percentage occupied, on average):

$$SINR = \frac{12 * RSRQ}{1 - ρ * RSRQ * 12} \qquad ( 2 )$$

where 12 is the number of OFDM sub-carriers in an LTE PRB, RSRQ at the numerator is the RSRQ aggregated on an MDT data pixel basis, in linear scale. RSRQ is defined as (N_{PRB}×RSRP)/RSSI, where N_{PRB} is the number of resource blocks of the E-UTRA carrier RSSI measurement bandwidth. Since the RSRP is a measurement of the demodulated CRS symbols, the numerator accounts only for the co-channel serving cell signal contribution. In contrast, the denominator's RSSI is a wideband measure of co-channel serving and non-serving cells, adjacent channel interference, and noise. As a consequence, the RSRQ-based pixel SINR is a better descriptor of the SINR when performance are limited by interference and susceptible to load variations in the cells, compared to the RSRP-based pixel SINR, where SINR is evaluated as a ratio of reference signals demodulated powers.

The pixel-level aggregated quantities pixel WEIGHT, pixel RSRP and pixel SINR calculated by the (Aggregated values calculator module 425 of the) pre-processing module 405 are provided (reference numeral 435 in FIG. 4) to the A calculator module 410.

### Simulated Network Environment 305: A Calculator Module 410

For every MDT data pixel pxᵢ of the geographical area of interest 105, two deviations, or “deltas”, are calculated:
a first “delta”, ΔR, is calculated as the difference, in dB, between the pixel-level aggregated quantity pixel RSRP obtained from the aggregation of the RSRP measurements present in the MDT data samples belonging to the considered MDT data pixel pxᵢ—linear average of the RSRP measurements present in the MDT data samples belonging to the considered MDT data pixel pxᵢ, as described above (also referred to as “MDT RSRP” in the following) and the RSRP calculated by the electromagnetic field propagation simulator 325 for that same pixel pxᵢ (also referred to as “Simulator RSRP” in the following), and
a second “delta”, ΔS, is calculated as the difference between the pixel-level aggregated quantity pixel SINR obtained from the aggregation of the MDT pixel data
according to one of the two possible methods described above, Eq. 1 or Eq. 2 (also referred to as “MDT SINR” in the following)—and the SINR obtained by the electromagnetic field propagation simulator 325 for that same pixel pxᵢ (also referred to as “Simulator SINR” in the following).

For example, the electromagnetic field propagation simulator 325 calculates the Simulator SINR for a generic pixel pxᵢ of the area of interest 105 as a ratio between the power of the best-server cell and the power of a certain number (N) of the best interfering cells (i.e., the n network cells whose power is higher in the considered pixel).

If the MDT SINR is calculated according to Eq. 1 above, a single value of the second delta ΔS is obtained, being the difference, in dB, between the MDT SINR calculated as a ratio of powers (Eq. 1) by the pre-processing module 405 and the Simulator SINR calculated by the electromagnetic field propagation simulator 325.

If the MDT SINR is calculated according to Eq. 2 above, n different values of the second delta ΔS, [ΔSρ1, ΔSρ2, . . . , ΔSρn], are obtained: a different second delta value ΔSρk is calculated for each possible value of average percentage ρₖ of occupation of the PRBs observed on the network cells of the geographical area of interest 105 (quantized in time bands coherent with the time bands used to aggregate the MDT data).

### Simulated Network Environment 305: Configuration Change Effects Calculator Module 415

The Configuration change effects calculator module 415 is configured so that, in operation, it implements the effects of the change in the configuration of the parameters of the Target cells 110 on the simulated network environment 305 (in consequence to actions performed on the simulated network environment 305 by the DRL Agent 330). Based on the effects, on the simulated network environment 305, of the Target cells' configuration parameters changes calculated by the Configuration change effects calculator module 415, the Reward calculation module 420 calculates and returns to the DRL Agent 330 a reward 430 (immediate reward, after each step during an Episode, cumulative reward, at the end of an Episode), described in greater detail later on.

Considering for example the case in which the cells' configuration parameters on which the DRL Agent 330 can act are two, e.g., electrical antenna tilt and beamforming pattern, the Configuration change effects calculator module 415 is configured so that, in operation, it implements a set of procedures for the evaluation of the effects of changes of both of the Target cells' configuration parameters.

The Configuration change effects calculator module 415 keeps track (block 417, Past actions of Episode) of the actions taken by the DRL Agent 330 during an Episode, for purposes that will be explained in detail later on.

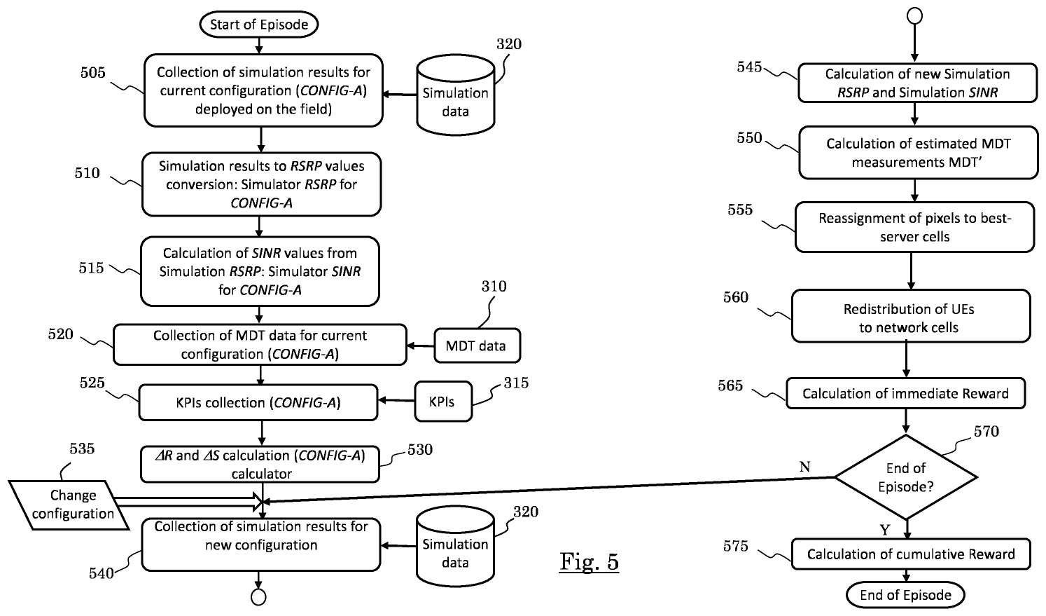

Such procedures for evaluating the effects of the changes are described herebelow. A procedure for evaluating the effects, on the simulated network environment 305, of the change in electrical antenna tilts of the Target cells 110 is discussed first, with the aid of the schematic flowchart of FIG. 5; procedures for evaluating the effects, on the simulated network environment 305, of the change in beamforming parameters of the Target cells 110 are discussed afterwards.

### 1—Procedure for Evaluating the Effects of Changes of the Electrical Antenna Tilts on the Simulated Network Environment 305

In an embodiment of the solution disclosed herein, the procedure for evaluating the effects of changes of the electrical antenna tilts of the Target cells 110 on the simulated network environment 305 comprises the following procedural phases.

### Phase a)

The procedure starts with a current configuration CONFIG-A of the network cells (Target cells 110 and Adjacent cells 115) of the area of interest 105. By “current configuration CONFIG-A” it is meant the configuration of the network cells currently deployed on the field, which includes a current configuration of the electrical antenna tilts of the Target cells 110 and the Adjacent cells 115.

As schematized by block 505, electromagnetic field propagation data resulting from the simulations carried out by the electromagnetic field propagation simulator 325 in respect of the current configuration CONFIG-A of the network cells (Target cells 110 and Adjacent cells 115) of the area of interest 105 are collected from the (repository of the) results of electromagnetic field propagation simulations 320, pixel by pixel.

The electromagnetic field propagation data resulting from the simulations of the current configuration CONFIG-A are converted into RSRP values (in the following also referred to as “Simulator RSRP”), pixel by pixel, block 510. SINR values (in the following also referred to as Simulator SINR) are calculated, pixel by pixel, from such calculated RSRP values, for the current configuration CONFIG-A, block 515. The quantities Simulator RSRP and Simulator SINR are calculated as explained in the foregoing.

### Phase b)

MDT data 310 from the field associated with the current configuration CONFIG-A of the network cells are also collected, block 520.

As discussed in the foregoing in connection with the Pre-processing module 405, the collected MDT data are (filtered by time band and) grouped (aggregated) together (based on the geolocation of the MDT data samples) in MDT data pixels pxᵢ that correspond to the pixels pxᵢ of the results of the electromagnetic field propagation simulations 320.

### Phase c)

Network performance parameters (KPIs 315) are collected, block 525. In the exemplary embodiment here described, the network performance parameters are the Key Performance Indicators (KPIs). Useful KPIs are:
#avg active UEs: average number of UEs (i.e., users) active for Transmission Time Interval (TTI, e.g., 1 ms in LTE), averaged on a predetermined time interval (e.g., 15 minutes, 1 hour, 2 hours etc.);
% PRB usage: this is the average percentage ρ of occupation of the PRBs in

the network cells of the geographic area of interest 105.

The two KPIs are collected on a network cell basis.

The first KPI, #avg active UEs, is redistributed on the MDT data pixels pxᵢ covered by the considered network cell coherently with the characteristic weight WEIGHT, wᵢ of each MDT data pixel pxᵢ, calculated as explained in the foregoing (section WEIGHT). The overall sum of the average numbers of UEs active for TTI in the considered network cell is normalized and associated to the MDT data pixels pxᵢ of the network cell based on the weights wᵢ assigned to each pixel pxᵢ. The generic MDT data pixel pxᵢ is thus associated with a respective percentage (depending on the pixel weight w,) of the overall sum of the average numbers of UEs active for TTI in the considered network cell. The sum of the average numbers of UEs active for TTI associated to the various pixels pxᵢ in a considered network cell is thus equal to the overall sum of the average numbers of UEs active for TTI in the network cell. For example, if #avg active UEs=10 and the considered network cell covers 10 pixels pxᵢ all having the same weight wᵢ, one UE is associated with each pixel pxᵢ.

The second KPI, % PRB usage, is used for calculating the MDT SINR of every MDT data pixel pxᵢ (by the pre-processing module 405) as indicated in Eq. 2 above.

### Phase d)

Deviations, i.e., differences (“deltas”) ΔR between the MDT RSRP and the Simulator RSRP, and ΔS between the MDT SINR and Simulator SINR, calculated as described in the foregoing (by the A calculator module 410), are computed, block 530. The deviations ΔR and ΔS between the MDT RSRP and the Simulator RSRP, and between the MDT SINR and Simulator SINR, are calculated in respect of the current configuration CONFIG-A and are then assumed to be invariant, i.e., to not depend on the changes in the configuration parameters (electrical antenna tilts, in the case considered here) of the Target cells 110 (particularly, not dependent on changes of the simulated network environment 305 consequent to actions performed on it by the DRL Agent 330).

### Phase e)

When the DRL Agent 330 acts on the simulated network environment 305 to request a change in the configuration parameters of one or more of the Target cells 110 (action 535), the electromagnetic field propagation data resulting from the simulations carried out by the electromagnetic field propagation simulator 325 in respect of the changed, new network configuration CONFIG-B₁ of the network cells (Target cells 110 and Adjacent cells 115) of the area of interest 105 are collected from the (repository of the) results of electromagnetic field propagation simulations 320, pixel by pixel (block 540).

### Phase f)

As made for the previous network configuration CONFIG-A, the electromagnetic field propagation data resulting from the simulations of the new, modified network configuration CONFIG-B₁ are converted into a new Simulator RSRP value, pixel by pixel, and a new Simulator SINR value is calculated (according to Eq. 1 or Eq. 2 above), pixel by pixel, for the new configuration CONFIG-B₁ (block 545).

### Phase g)

Estimated MDT measurements MDT′ are calculated, pixel by pixel (block 550). The estimated MDT measurements MDT′ are calculated by adding to the Simulator RSRP values and to the Simulator SINR values calculated in phase f) the deviations ΔR and ΔS (which, as explained before, are assumed to be invariant to changes in the configuration of the network cells).

### Phase h)

The pixels pxᵢ are reassigned to the respective best-server network cells according to the principles of Cell Reselection in IDLE mode (without hierarchical thresholds in that single-layer), block 555. The reassignment of the pixels pxᵢ can be made in accordance with a maximum RSRP criterion: if a certain pixel pxᵢ results to be served with, e.g., a value of RSRP RSRP_{A} by a certain network cell A and with a value of RSRP RSRP_{B} by another network cell B, that pixel pxᵢ is reassigned to network cell B if RSRP_{B}>RSRP_{A}.

### Phase i)

The redistribution of UEs to the network cells as a consequence of the change in configuration is performed, block 560.

As a result of phase h), the generic pixel pxᵢ can be reassigned to another, new network cell (different from the network cell to which that pixel was assigned prior to the change in network configuration). If this happens, the percentage of active UEs assigned to that pixel pxᵢ (see phase c) before) is also reassigned to the new network cell. After the pixels have been reassigned to the respective best-server network cells as in phase h), the sums of the average active UEs per network cell are recalculated. For example, if a certain network cell A has 10 active UEs and network cell A covers 10 pixels all with equal weight, one UE is assigned to each pixel of network cell A. Let it be assumed that, with the new network configuration, one of the pixels previously assigned to network cell A is reassigned to a different network cell B: then, the overall number of active UEs in network cell A drops to 9.

### Phase j)

The Reward calculator module 420 calculates a Reward 430 (immediate reward) for the new configuration CONFIG-B₁ (block 565). The way the calculation of the Reward is accrued out will be described in detail later on.

Every time, during an Episode, the DRL Agent 330 commands a change in the configuration to the simulated network environment 305 (CONFIG-A→CONFIG-B₁→CONFIG-B₂→CONFIG-B₃→etc.), phases e) to j) are iterated (decision block 570, exit branch N), and each time an immediate reward 430 is calculated and returned. These operations are repeated till a current Episode is completed (decision block 570, exit branch Y). At the end of the Episode, the Reward calculator module 420 calculates a cumulative Reward (block 575) which is provided to the DRL Agent 330 (the cumulative Reward is denoted 430, as the immediate Reward; the cumulative Reward can be calculated by adding the immediate Rewards calculated for each iteration/step of the Episode).

The operations of phases e) to j) described above are repeated every Episode.

### 2—Procedure for Evaluating the Effects of Changes of the Antenna Beamforming Parameters on the Simulated Network Environment 305

Similarly to what done for evaluating changes in electrical antenna tilts, also changes in the antennas' beamforming parameters (the beamforming parameters determine a “beamset”, which is the envelope of the antenna radiation diagram: depending on how many beams are used and how the different beams are used, different beamsets are obtained) could be simulated by the electromagnetic field propagation simulator, and the deviations (“deltas”) between the RSRP and the SINR derivable from the MDT data 310 collected from the field (MDT RSRP and MDT SINR) and the RSRP and the SINR resulting from the simulations carried out by the electromagnetic field propagation simulator (Simulator RSRP and Simulator SINR) could be calculated, as in phase g) above.

An alternative procedure, according to an embodiment of the solution disclosed herein, to evaluate the effects of changes in the antennas' beamforming parameters (beamset) on the estimated MDT measurements for RSRP and SINR is described herebelow. The procedure is based on software functions.

The Applicant has realized that an issue to be considered is the possible shortage of 5G MDT data samples at 3.7 GHz (due to the still relatively limited territorial coverage by 5G networks, and/or the relatively small number of 5G UEs, and/or the limited implementation of the MDT mechanism in 5G networks). The scarcity of 5G MDT data samples at 3.7 GHz may lead to a statistical insufficiency of the MDT data collected from the field as far as the 5G network is concerned.

The Applicant has found that, in order to overcome this problem, 4G MDT data samples at 1800 MHz from the field can be exploited, assuming to simulate a feature (the beamforming) that belongs to 5G networks on MDT data samples and frequencies belonging instead to the 4G network.

It is underlined that this approach is not limiting, because once sufficient 5G MDT samples from the field will become available, it will be sufficient to re-train the DRL Agent 330 on a new distribution of 5G MDT data samples.

Procedures for simulating the effects of changes in the antennas' beamforming parameters of the network cells on the values of RSRP and SINR are now described.

### RSRP:

Given a campaign of 4G MDT measurements from the geographic area of interest 105 (like the MDT data 310), the transmission gain of the base station (eNode-B) is obtained for each 4G MDT data sample by means of the following procedure.

i)

The antennas' radiation diagrams (on the horizontal and vertical planes) are collected, for the antennas corresponding to the Target network cells 110 of the area of interest 105. An exemplary antenna radiation diagram on the horizontal plane is shown in FIG. 6.

ii)

Based on the collected 4G MDT data 310, for each UE, the values of parameters BEAM_H and BEAM_V are calculated. The parameters BEAM_H and BEAM_V are defined as:
BEAM_H [+/−180° ] is the angular deviation on the horizontal plane of the line joining the network cell (i.e., the base station) to the UE, in relation to the direction of maximum horizontal radiation in Azimuth of the network cell. The geographic coordinates of both the network cell and the UE are assumed to lie on the ellipsoid describing the Earth's surface, i.e., no account is taken for the difference in altitude of the two geographic (e.g., GPS) positions of the cell and of the UE.
BEAM_V is the angle of misalignment with respect to the maximum of radiation on the vertical plane. It is calculated as the arctan of the ratio between the sum of the altitude of the cell's antennas and the altitude of cell with respect to its base, and the distance between the GPS position of the cell and that of the UE.
   iii)

The deviation with respect to the maximum radiation gain is calculated by associating the values BEAM_H and BEAM_V to the radiation diagrams of the best-server cell antenna (taken as the reference antenna).

This procedure introduces the following approximation: the values of the parameters BEAM_H and BEAM_V calculated based on the collected 4G MDT data 310 are “geometrical” misalignment angles with respect to the radiation maximum, i.e., they are calculated based on the relative GPS positions of the UEs and the cell (including the height of the cell's site). Such “geometrical” values of the parameters BEAM_H and BEAM_V correspond to the actual main electromagnetic arrival angle only in the case that the UE is in Line of Sight (LoS). Thus, if a UE which is not in LoS (i.e., it is in NLoS) receives a reflected path as main path (e.g., through a local maximum in the radiation gain), the antenna gain estimated by the described procedure could be slightly lower or higher compared to the actual antenna gain. However, by dividing the link equation (Received power=transmitted power+gains−losses, where the term losses is considered to include every possible loss along the channel) between transmitter, channel and receiver, the error introduced in this estimation of the directional antenna gain (being known the model of the transmitting antenna) is negligible compared to the many other variables that come into play: in fact, the information on the channel attenuation and gain of the receiver depends on several, more important elements like the propagation environment, the LoS/NLoS condition of the UE, the material and height of the buildings, the specific UE model, the absorption by the human body, etc. Thanks to the empirical nature of the collected MDT data 310, all such elements are “embedded” in the observed RSRP contained in the collected MDT data 310. Experimental trials performed by the Applicant have shown that the proposed estimation of the gain is effective in estimating plausible pathloss data, performing a comparison with well-established propagation models.

Moreover, the problem of estimating the electromagnetic arrival angle will be partially solved once sufficient 5G MDT data will be available, since for each measurement the information about the arrival angle at the level of SSB beam will be present.

The RSRP modified according to the introduction of the 5G beamset can be obtained by replacing the estimated antenna gain (estimated as just described above) from a 4G antenna with the estimated envelope antenna gain from a 5G beamforming antenna. In particular, the deviation between the two estimated antenna gains is calculated (e.g., estimated 4G antenna gain=10 dB, estimated 5G antenna gain=16 dB→deviation=+6 dB) and the calculated deviation is applied to the initial RSRP value taken from the 4G MDT data 310, thereby obtaining a modified RSRP value RSRP′.

This method is justified by the fact that the RSRP is a narrow-band measurement performed by demodulating the LTE channel reference signal, thus it does not depend on the interference (which instead experiments a strong variation downstream the introduction of beamforming).

### SINR:

The calculation of the SINR for every 4G MDT data sample can be made in a way similar to what explained in the foregoing. The MDT data 310 reported by the UEs from the field contain inter alia the radio power level received from the best-server cell and also the radio power level received from the interfering cells (ranked in order of received interfering power level). After the calculation of the modified RSRP value RSRP′ as described above, the effect of the change on the numerator and on the denominator of the following equation (Eq. 3):

$${SINR}^{′} = \frac{{RSRP}_{Pcell}^{′} [ mW ]}{{\sum }_{i = 1}^{N} ( \frac{{RSRP}_{, icell}^{′}}{{N}_{beams}} ) [ mW ] + {N}_{0} [ mW / Hz ] * {B}_{ℜ} [ Hz ]} \qquad ( 3 )$$

can be evaluated, to obtain a value SINR′.

Under the assumption of an analogic beamforming, which implies that a single beam is used at a time, i.e., the different beams are used on a time-division basis, the inter-beam intra-cell interference (i.e., interference among beams of the same cell) can be considered to be zero. Moreover, for the same reason, Eq. 3 differs from Eq. 1 for the factor 1/N_{beams} in the denominator, where N_{beams} represents the number of Synchronization Signal Block (SSB) beams, introduced for accounting the fact that the interfering beam will be active (statistically, averaging on all the cells adjacent to the primary cell) with probability 1/N_{beams}.

It is pointed out that there is a trade-off between the advantages deriving from the use of several highly-directional antenna beams (N_{beams} in Eq. 3 above), which is advantageous in terms of interference reduction (and thus improves the SINR′), and the signalling overhead caused by the beam management procedures defined by the 3GPP standard.

In case the MDT SINR is calculated based on the RSRQ, as in Eq. 2 in the foregoing, the deviation (“delta”) between the SINRs is calculated using Eq. 1 and Eq. 3:

$$\begin{matrix}Δ S = MDT SINR - {SINR}^{′} \\ = \frac{{RSRP}_{Pcell} [ mW ]}{{\sum }_{i = 1}^{N} {RSRP}_{, icell} [ mW ] + {N}_{0} [ mW / Hz ] * {B}_{ℜ} [ Hz ]} \\ - \frac{{RSRP}_{Pcell}^{′} [ mW ]}{{\sum }_{i = 1}^{N} ( \frac{{RSRP}_{, icell}^{′}}{{N}_{beams}} ) [ mW ] + {N}_{0} [ mW / Hz ] * {B}_{ℜ} [ Hz ]}\end{matrix}$$

and the calculated “delta” is applied to Eq. 2:

$$\frac{12 * RSRQ}{1 - ρ * RSRQ * 12} + Δ S .$$

Apart from the described peculiarities of the alternative procedure for evaluating the effects of changes in the antennas' beamforming parameters (beamset), the phases of the method described above in connection with the evaluation of the changes in electrical antenna tilts also apply to the evaluation of the effects of changes in the antenna beamforming parameters. In particular, phases h), i), j) of the method described in the foregoing remain valid.

### Simulated Network Environment 305: Reward Calculator Module 420

The reward calculator module 420 is configured so that, in operation, it calculates the reward 430 (immediate reward, after each step of an Episode, and cumulative reward, after the conclusion of an Episode).

For the calculation of the reward 430, the Reward calculation module 420 uses a reward function, which is an indicator of the overall performance of the network (in a certain configuration). In an embodiment of the solution disclosed herein, the reward function is made up of two elements:
a first element provides an estimation of the overall throughput (final throughput) being an average user throughput, and
a second element is a cost function which attributes a cost to violations of coverage constraints (by coverage it is meant the fraction—in percentage—of area that has to be covered by the network signal. If a certain geographical area is not covered by the network signal, such area is said to be in outage. Typically, the percentage of area in coverage should be around 99%, and this is a coverage constraint).

The overall average user throughput (first element of the reward function) is defined as:

$${U}_{avg - per - cell} = {η}_{MCS , cell} [ bits / s / Hz ] * {N}_{PRB , cell} * 180 [ KHz ]$$

where U_{avg-per-cell} is the average user throughput by cell, η_{MCS,cell} is the average spectral efficiency by cell, N_{PRB,cell} is the average number of PRBs available per user at the cell level (average number of scheduled PRBs per UEs per cell) and 180 [KHz] is the PRB bandwidth. The average spectral efficiency by cell η_{MCS,cell} can be obtained as a weighted average of the spectral efficiency by pixel t_{MCS,i}:

$${η}_{MCS , cell} = \frac{1}{\sum {w}_{i}} {\sum }_{i = 1}^{Npixel} {w}_{i} * {η}_{MCS , i}$$

where wᵢ is the weight of the pixel pxᵢ, calculated as described in the foregoing (section WEIGHT) and Σwᵢ is the sum of the weights of all the pixels of the cell.

Pixel's spectral efficiency η_{MCS,i} is obtained according to a Channel Quality Indicator (CQI)-Modulation and Coding Scheme (MCS) mapping compliant to 3GPP Technical Specification TS 36.213, Table 7.2.3-2, in which the maximum MCS is determined allowing a packet error rate of 10%. The CQI is not uniquely identified by SINR, as it also depends on the implementation of the UE's receiver: a sophisticated receiver can collect the incoming data at a lower SINR than a more basic one. The estimated SINR=Simulator SINR+ΔS of the considered pixel pxᵢ can be then mapped to CQI assuming fixed receiver performance.

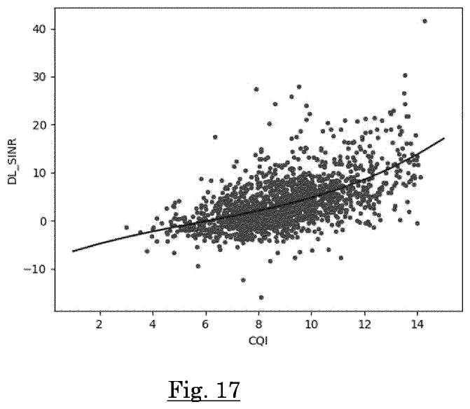

In order to derive an empirical law for the mapping between CQI and SINR, and MDT data, the Applicant has conducted an analysis on a reference territory and has found that a best-fit line of polynomial degree 3 approximates the average MDT SINR values (y-axis) for different values of average CQI (x-axis), as shown in FIG. 17. The following table provides a mapping between SINR, CQI and MCS:

| CQI | SINR | | Modulation | Code rate | Spectral Efficiency |
|---|---|---|---|---|---|
| 0 | — | | — | — | — |
| 1 | −6.4 | dB | QPSK | 0.076 | 0.1524 |
| 2 | −4.8 | dB | QPSK | 0.19 | 0.377 |
| 3 | −3.4 | dB | QPSK | 0.44 | 0.877 |
| 4 | −2.2 | dB | 16-QAM | 0.37 | 1.4764 |
| 5 | −1.2 | dB | 16-QAM | 0.48 | 1.914 |
| 6 | −0.1 | dB | 16-QAM | 0.60 | 2.4064 |
| 7 | 0.9 | dB | 64-QAM | 0.46 | 2.7306 |
| 8 | 2.1 | dB | 64-QAM | 0.55 | 3.3222 |
| 9 | 3.3 | dB | 64-QAM | 0.65 | 3.9024 |
| 10 | 4.8 | dB | 64-QAM | 0.75 | 4.5234 |
| 11 | 6.5 | dB | 64-QAM | 0.85 | 5.115 |
| 12 | 8.5 | dB | 256-QAM | 0.69 | 5.5544 |
| 13 | 10.9 | dB | 256-QAM | 0.78 | 6.2264 |
| 14 | 13.8 | dB | 256-QAM | 0.86 | 6.9072 |
| 15 | 17.1 | dB | 256-QAM | 0.93 | 7.4064 |

The average number of PRBs available per user at the cell level N_{PRB,cell} depends on the scheduling mechanism employed and can be calculated in accordance with two possible scheduling models: “round-robin” scheduling and “fair” scheduling.

With the round-robin scheduling, every user (i.e., every UE) is treated in the same manner, regardless of its channel condition:

$${N}_{PRB , cell} = \frac{{N}_{PRB , TOT} - Thr}{{N}_{UE , CELL}}$$

where N_{PRB,TOT} is a constant indicating the number of PRBs available for each LTE frequency band (100 PRBs for the 1800 MHz band), Thr is a safety PRB occupancy threshold, and N_{UE,CELL} is the average number of active user by cell.

With the fair scheduling, every user is assigned a different percentage of PRBs, in order to balance the cell-edge performance; the users are subdivided in M classes depending on their channel condition (the first class corresponding to the best channel condition and the last, M^{th} class corresponding to the worst channel condition):

$${N}_{PRB , cell} = \frac{{N}_{PRB , TOT} - Thr}{{\sum }_{i = 1}^{M} {β}_{i} {N}_{UE , CELL , i}}$$

where the term βᵢ varies between β₁ and β_{M}. A user of the M^{th} class (worst channel condition) is assigned a number of PRBs which is M times greater than the number of PRBs assigned to a user in the first class (best channel condition).

The final throughput is calculated as a linear weighted average of the average user throughput per cell:

$${U}_{final} = \frac{1}{{N}_{TOT}} {\sum }_{j = 1}^{Ncell} {N}_{UE , j} * {U}_{avg - per - cell , j}$$

As pointed out in the foregoing, there is a trade-off between the advantages of using several highly-directional antenna beams in terms of reduced interference (increased number of beams N_{beams} which improves the SINR) and the signalling overhead due to the standard procedures for the management of the beams. In order to take account for this trade-off, a protocol overhead factor η_{protocol} is applied to the final throughput U_{final}. Depending on the number of SSB beams used, the value of the final throughput U_{final} is multiplied by the protocol overhead factor η_{protocol} varying between 0 and 1 and inversely proportional to the number of beams used (i.e., 1 beam used→η_{protocol}=1).

The second element of the Reward function, or cost function, is a Heaviside function introduced for penalizing choices of actions that violate the coverage constraint (i.e., if the DRL Agent 330, during the Episode under consideration, takes actions that, at the end, do not fulfill the area coverage threshold Thr, then it is penalized with a negative reward).

The negative reward can be a value sufficiently negative for enabling the DRL Agent 330 to discriminate the effects of a selected action that violates the coverage constraint from the effects of a selected action that does not violate the coverage constraint but nevertheless does not result in good network performance. For example, the second element, C, of the reward function can be defined as a Heaviside function:

$$C = \{ \begin{matrix}0 & if \% pixels in coverage \geq Thr \\ - 300 & if \% pixels in coverage < Thr\end{matrix}$$

where % pixels in coverage indicates the percentage of pixels that are in coverage.

The second element, C, of the reward function can be defined by other functions, e.g., an exponential function like the following:

$$C = \{ \begin{matrix}0 , & if 99 , 5 \% <= \% {A}_{cov} <= 100 \% \\ \frac{1}{3 , {45795}^{( \% {A}_{cov} - 102 , 6 )}} - 1 , & if 98 \% <= \% {A}_{cov} < 99 , 5 \% \\ 300 , & otherwhise\end{matrix}$$

where % A_{cov} denotes the percentage of area in coverage:

$$\% {A}_{cov} = \frac{{\sum }_{i = 1}^{{N}_{pc}} {w}_{i}}{{\sum }_{j = 1}^{{N}_{p}} {w}_{j}}$$

As a consequence, pixels carrying more traffic are statistically more relevant.

A generic pixel is considered in coverage if the following two conditions are met:

$$RSRP pixel > - 125 dBm \to Noise limited conditions \qquad 1 )$$

$$SINR pixel > - 6.4 dB \to Interference limited conditions \qquad 2 )$$

The value of −6.4 dB for the SINR pixel is taken from the above table of CQI-SINR-MCS; more generally, condition 2) is SINR pixel>minimum acceptable level of SINR.

Additionally, thanks to the characteristic weight wᵢ assigned to each MDT data pixel pxᵢ, the percentage of pixels in coverage should not consider the coverage area on an equal basis, rather through a weighted sum: those pixels pxᵢ experiencing a higher traffic (and thus being characterized by a higher pixel weight wᵢ) are more important, in the determination of the coverage, than the pixels pxᵢ experiencing a lower traffic:

$$\% Pixels in coverage = \frac{\{ \begin{matrix}{\sum }_{i = i}^{Npixel} {w}_{i} & if pixel pxi is in coverage \\ {\sum }_{i = i}^{Npixel} 0 & if pixel pxi is in outage\end{matrix}}{{\sum }_{i = 1}^{Npixel} {w}_{i}}$$

The reward function is thus expressed as:

$$Reward function = {U}_{final} * {η}_{protocol} + C$$

### Deep Reinforced Learning (DRL) Agent 330

The DRL Agent 330 will be now described in detail.

The optimization of a mobile communications network is a complex problem, both under the viewpoint of the actions space (the solutions space is n_params^{n_cells}, where n params is the number of modifiable cells' parameters and n_cells is the number of network cells whose parameters can be modified; this makes the network optimization a NP-hard problem) and under the viewpoint of the space of the observations that the DRL Agent 330 performs by interacting with the simulated network environment 305.

According to the solution disclosed herein, the DRL Agent 330 exploits a Convolutional Neural Network (CNN) and the input layer received by the CNN is the observed state of the simulated network environment 305.

In embodiments of the solution disclosed herein, the state of the simulated network environment 335 observed by the DRL Agent 330 (observed state) is defined as a matrix of dimension equal to the overall number (p*q) of pixels pxᵢ of the geographical area of interest 105 (in the exemplary case here described, the area of interest 105 includes a number of(105*106) pixels). In such embodiments, the matrix describing the observed state has, for each pixel pxᵢ, a number of channels equal to the number of Target cells 110 (i.e., those cells on which an action of change of a configuration parameter can be taken; every Target cell has associated therewith a channel which corresponds to the action taken on such cell for changing a single one of its configurable parameters) plus the three values WEIGHT (wᵢ), RSRP and SINR for the considered pixel pxᵢ.

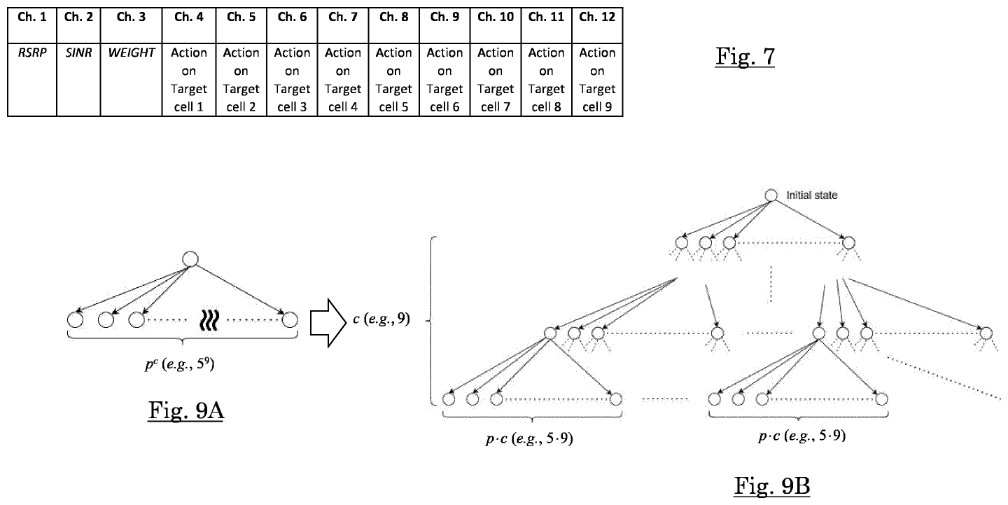

For example, as depicted in FIG. 7, in the exemplary case of 9 Target cells 110, the matrix describing the observed state of the simulated network environment 305 includes, for a generic pixel pxᵢ of the area of interest 105, 12 channels Ch. 1, Ch. 2, . . . , Ch. 12 (9 channels, each corresponding to the action taken by the DRL Agent 330 on a respective one of the 9 Target cells, plus the three channels WEIGHT—wᵢ—, RSRP and SINR for the considered pixel).

RSRP is used to manage mobility and identify coverage issues. WEIGHT is used to distinguish between most and less relevant pixels. SINR is used for the computation of the throughput.

More generally, for a number n of Target cells 110, the matrix describing the observed state of the simulated network environment 305 includes, for a generic pixel pxᵢ of the area of interest 105, a number of channels equal to (n+3).

Later on in this document, another, preferred embodiment of the disclosed solution is presented in which the input to the CNN and the CNN has a different structure, particularly the matrix describing the observed state has a different (lesser) number of channels (the three channels WEIGHT—wᵢ—, RSRP and SINR, instead of n+3 channels, where n is the number of Target cells).

It would not be practically possible to face such a complex problem by using classical value-based reinforced learning algorithms like Q-Learning.

As known to those skilled in the art, Q-Learning is a model-free reinforcement learning algorithm to learn the value of an action in a particular state, that does not require a model of the environment (hence it is “model-free”). The Q-Learning algorithm essentially consists of learning a Q-values table (‘Q’ being for quality) that contains the expected future reward for each state and action. Based on the Q-table, the Agent is capable of making the best choice for each state by choosing the action that maximizes the expected future rewards. The Q-Learning algorithm becomes quickly inefficient when dealing with a complex environment with various possibilities and outcomes.

The solution disclosed herein proposes a different approach, based on Deep Neural Networks (DNNs) for estimating Q values (Approximated Q-Learning with DNN or Deep-Q Learning, also referred to as Deep Q Network or DQN).

As known, a Deep Neural Network (DNN) is an Artificial Neural Network (ANN) with multiple layers between the input and output layers.

In particular, the solution here disclosed exploits a Convolutional DNN.

Deep-Q Learning and DQNs are known and widely used in the art. Deep-Q Learning mainly consists of building and training a DNN capable of estimating, given a state, the different Q-values for each action. In this way, DQNs are better when dealing with a complex environment with various possibilities and outcomes.

However, DQNs are affected by a problem of “sample inefficiency”, because the Agent hardly explores the space of the states in an exhaustive way.

The Applicant has faced the problem of improving the sample efficiency of the DQN.

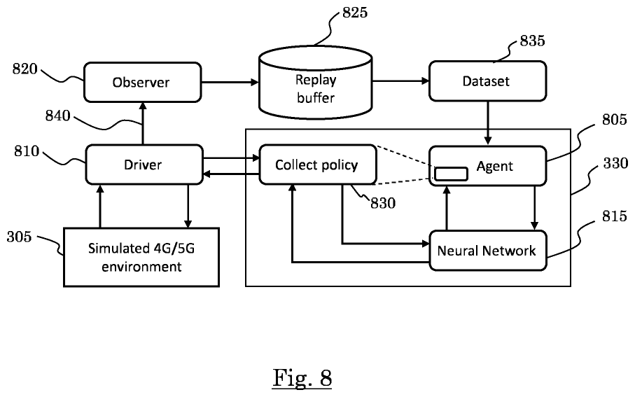

FIG. 8 depicts the architecture of the DRL Agent 330, in terms of logical/functional modules. In particular, the DRL Agent 300 is a DQN Agent, for example a TensorFlow Agent, built using Google's TensorFlow framework and library.

Generally stated, a generic Agent, e.g., a DRL Agent, is defined by a set of parameters, among which an important parameter is the neural network, which can be a Q network (in which case the DRL Agent is a DQN Agent), a value network, an actor network. The DRL Agent 330 comprises an Agent 805, a neural network (particularly, a CNN) 815, and a collect policy (or behaviour policy) module 830. The DRL Agent 330 interacts directly with the Environment, which in the solution here disclosed is the simulated network environment 305, through a driver module 810. The driver module 810, according to a certain policy (“exploration policy”, e.g., Greedy policy, Epsilon-Greedy policy, others policies as described later on) defined by the collect policy module 830, takes actions on the simulated network environment 305, either by directly querying the neural network 815 of the DRL Agent 330, in order to take advantage of the acquired knowledge, or undertaking a casual action, in order to explore other possible network configurations during training time.

The sequences of the interactions between the driver module 810 and the simulated network environment 305 are monitored by an observer module 820. The observer module 820 is linked to a replay buffer module 825, which is a repository from which samples are extracted to generate, during the Agent's 805 training time, the dataset for training the Agent 805. Possibly, the observer 820 is also linked to metrics descriptors configured to monitor information about the training process and the simulated network environment 305 (like the average reward obtained, the overall number of episodes, the sequence of actions performed on the simulated network environment 305).

The collect policy module 830 defines the approach (behaviour) according to which the Agent 805 explores the simulated network environment 305 (i.e., the exploration policy). The approach defined by the collect policy module 830 can be more “explorative”, meaning that the Agent 805 will be likely to perform random actions, or “exploitative”, meaning that the Agent 805 will rely on previously acquired knowledge (i.e., estimated Q-values) in selecting an action to take.

A dataset module 835 is a container of the observations on which the Agent 805 is trained, as it happens for all the machine learning and deep learning models. The dataset module 835 is sampled from the replay buffer module 825.

A trajectory 840 is composed of a sequence of observations related to subsequent simulated network environment 305 steps of an Episode. A set of trajectories 840 are stored within the replay buffer module 825. The driver module 810 and the collect policy module 830 are bidirectionally connected with the Agent's 805 neural network 815 since they feed to the neural network 815 the information regarding the time step (Environment's step, i.e., the observation) and they receive from the neural networks 815 the advice regarding the suggested action, which will be employed in case the current collect policy will follow an exploitative approach instead of a purely random approach.

The Agent 805 samples batches of data from the dataset module 835 in order to perform the training phase, as usual for deep learning models.

According to the solution here disclosed, in order to improve the sample-efficiency of the DQN the actions described in the following have been taken.

### First Improvement Action

An RL approach requires a formulation of the optimization problem as a Markov Decision Process, in which the action-space, state-space, and reward must be appropriately defined.

A first improvement action regards the action-space and consisted in reformulating and re-casting the network optimization problem (reformulating the action-space) as an Episode of a certain length (i.e., comprising a certain number of steps, e.g., equal to the number of Target cells 110), representable as a tree (deep-tree) Markov Decision Process (MDP), where the depth of the tree depends on the number of cells. One Episode comprises a sequence of consecutive actions performed by the DRL Agent 330 on the simulated network environment 305. The number of consecutive actions performed by the DRL Agent 330 on the simulated network environment 305 is equal to the number of Target cells 110 in the area of interest 105, i.e., it is equal to the number of network cells in the area of interest 105 that have configurable parameters (e.g., electrical antenna tilt, or beamforming parameters). A generic action in the sequence of actions of an Episode (i.e., a generic step of an Episode) consists in modifying the value of one of the configurable parameters of one of the Target cells 110. For example, assuming that the Target cells 110 are 9, an Episode is (in principle) composed of a sequence of a predetermined number of actions (e.g., the number of actions of an Episode can be equal to the number of Target cells 110, 9 actions in the example here considered, or an Episode can be composed of a sequence of more actions than the number of Target cells 110). “In principle” because, as described in greater detail later on, according to an embodiment of the solution disclosed herein an Episode can be terminated in advance, i.e., before the completion of the nineth action in the example here considered (or, more generally, before the completion of all the predetermined steps composing the generic Episode), in case during a step of an Episode the DRL Agent 330 chooses an action to be performed attempting to modify the parameter of a Target cell 110 which, in a preceding step of that Episode, has already been object of an optimization attempt.

The DRL Agent 330, instead of selecting jointly the parameters for all the (e.g., 9) Target cells 110 and operating in an NP-hard actions space (as mentioned, the actions space is equal to p^{c}, where p denotes the number of tunable parameters and c denotes the number of Target cells 110 (number_of_parameters^{number_of_cells}) thus in the exemplary case of 9 Target cells 110 and assuming that the tunable parameter is the antennas' electrical tilts and that all the 9 Target cells have the same number 5 of possible electrical tilts (e.g., each corresponding to an additional −Δ3°), the actions space is 5⁹≅1.9 millions of possible actions—FIG. 9A), selects the configuration parameter (e.g., the value of the electrical antenna tilt) of one Target cell 110 at a time, in addition to selecting the Target cell to which the new configuration parameter is to be applied. In this way, as schematized in FIG. 9B, every branch of the search tree has a number of possible actions (cardinality of the action set) equal to just p·c (number_of_parameters*number_of_cells, in the considered example, 5*9=45), and it is possible, by adopting an exploration policy which is efficient in facing the dilemma “exploration vs exploitation” (as described in greater detail shortly hereafter), to potentially explore the tree of the possible actions in a smart manner, ignoring the less promising branches (potential to sequentially prune the tree based on the estimated Q-values at training time).

### Second Improvement Action

A second action to improve the sample-efficiency of the DQN has been to modify the observations space so as to include information about the actions (past actions) taken in the preceding steps of a generic Episode.

In embodiments of the solution disclosed herein, referring by way of example to FIG. 7, the channels from Ch. 4 to Ch. 12 are of one-hot-encoding type (as known to those skilled in the art, in machine learning jargon a “one-hot” is a group of bits among which the legal combinations of values are only those with a single high—“1”—bit and all the others low—“0”): the value of a generic one of such channels Ch. 4 to Ch. 12 is set to “1” if, in the considered Episode, the DRL Agent 330 has already taken an optimization action (i.e., change of the value of the configuration parameter) on the Target cell 110 corresponding to that channel, whereas the value of such channel is set to “0” otherwise. In this way, pieces of information (“recurrent information”) about previous actions taken by the Agent in a considered Episode are included, through the channels, in the matrix of the state of the simulated network environment 305. As mentioned in the foregoing, another, preferred embodiment of the disclosed solution is presented later or in this document, in which the recurrent information about previous actions taken by the Agent in a considered Episode are similarly exploited, but not by including them in the channels of the matrix of the state of the simulated network environment 305.

Such recurrent information is important in the training phase, because the collected experiences (at the level of single steps in an Episode), which are stored in the replay buffer 825, are sampled in a random manner during the training time. Such random sampling from the replay buffer 825 allows losing the correlation between contiguous steps in a same Episode. However, irrespective of the fact that contiguous steps of a same Episode are sampled or, rather, uncorrelated steps of different Episodes are sampled from the replay buffer 825, the information about the actions undertaken by the DRL Agent 330 previously till the start of the current Episode is completely summarized in the observations space within the one-hot-encoding channels (from Ch. 4 to Ch. 12 in the example of FIG. 7, for the case of 9 Target cells 110, more generally, from the fourth channel to channel (n+3) for n Target cells 110) of the state at the time instant t. In this way, the DRL Agent 330, by simply receiving in input the instantaneous observation, also has a precise information about which actions have been undertaken previously, and in this way the DRL Agent 330 is facilitated in the procedure of learning which actions patterns (i.e., in the considered example of 9 Target cells 110, the choice of one among 9 contiguous actions) are effective for maximizing the future cumulative reward returned by the simulated network environment 305 at the end of the Episode.

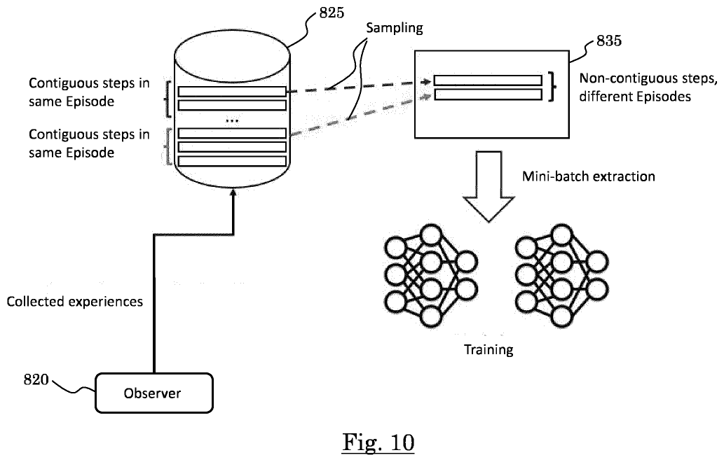

FIG. 10 schematizes the resulting Agent 805 training architecture.

Essentially, memory of the past actions is exploited, and a uniform replay buffer 825 with random sampling can be employed without losing information of Episodes' past actions. Although either two contiguous steps or two uncorrelated Episodes' steps are sampled during the mini-batch extraction, the Episode history information is fully preserved at any time.

### Third Improvement Action

As a third action to improve the sample-efficiency of the DQN, the calculation of the Reward 430 has been engineered (“Reward shaping”) in order to penalize certain actions that could be taken by the DRL Agent 330, so as to help the DRL Agent 330 learn (in shorter times) desired behaviours.

For example, in embodiments of the solution here disclosed, those actions patterns, taken by the DRL Agent 330, that violate some action constraints are penalized.

An exemplary action constraint that, if violated, is penalized is that, during an Episode, the actions taken by the DRL Agent 330 are not directed to modify again the configuration parameters of Target cells 110 that have already been modified in previous steps of the Episode. If the action chosen by the DRL Agent 330 at the generic step t of an Episode is directed to a Target cell 110 that has already been optimized previously (at a previous step) during the Episode, the reward (cumulative reward of the Episode) is set to a predetermined, for example negative, value, being a value sufficiently negative for enabling the DRL Agent 330 to discriminate the effects of selected an action that violates the constraint from the effects of a selected action that does not violate the constraint but nevertheless does not result in good network performance. The negative value can for example be −200 or −300. The Episode can be terminated at the first time the DRL Agent 330 chooses an action directed to a Target cell 110 that has already been object on an optimization attempt in earlier steps of that Episode. More generally the Episode can be terminated after a predetermined number of attempts, by the DRL Agent 330, to modify a parameter of a Target cell 110 that has already been object on an optimization attempt in earlier steps of that Episode (in this case, each time such an action is chosen by the DRL Agent 330, a negative reward value is returned).

As schematized in FIG. 4, the Configuration change effects calculator module 415 keeps track (block 417, Past actions of Episode) of the actions taken by the DRL Agent 330 during an Episode. If a new action 435 is received from the DRL Agent 330 that is recognized as an action of optimization of a Target cell 110 already object of a previous optimization action in the Episode, the Configuration change effects calculator module 415 notifies the Reward calculator module 420 and the latter may force (yet at the first time such an action is chosen by the DRL Agent 330, or more generally after a predetermined number of times an action of optimization of a Target cell 110 already object of a previous optimization action in the Episode) the termination of the Episode and applies the penalty to the reward 430.

### Fourth Improvement Action

A further, fourth action to improve the sample-efficiency of the DQN consists in the definition of a customized collection policy (exploration policy) to be actuated by the collect policy module 830 for introducing constraints (soft constraints) during the training time of the DQN, directed to “force” the Agent 805 to take, with a certain probability, “virtuous” actions, so that the Agent 805 can learn behaviours that would otherwise be very rare.

A known collect policy is the so-called F-greedy collect policy, which can be expressed as:
With probability (1−ε):
   perform greedy action
With probability ε:
   perform random action

For every step of an Episode this collect policy acts either randomly, with a probability ε, or “greedily”, with a probability of (1−ε), in this second case choosing to perform the actions with the highest Q-values.

Compared to a purely random collection policy, the F-greedy collect policy is more efficient: more time is spent in the exploration of more interesting branches of the search tree (because with the progress of the training, the estimations of the Q-values become better and better). At the same time, the purely random exploration of the search tree (with probability ε) preserves a certain flexibility, allowing the exploration of previously unexplored branches of the search tree.

According to the solution disclosed herein, an improvement to the known F-greedy collect policy is proposed. The improved collect policy is called “ε-η-greedy collection policy” and introduces an extra degree of freedom with respect to the known F-greedy collect policy: a f parameter that controls the probability of performing a “constrained random action”, that is, a random action sampled from a constraint-compliant set of actions. The ε-η-greedy collection policy can be expressed as:
With probability 1−ε:
   perform greedy action
With probability ε:
   with probability 1−η:
      perform constrained random action
   with probability η:
      perform random action
         and, in pseudocode:

```
i ← random(0,1)
j ← random(0,1)
∈ ← ∈_scheduling
η ← η_scheduling
if i ≥ ∈ then:
  perform greedy action
else
  if j ≥ η then:
    perform constrained random action
  else
    perform random action
  end if
end if
```

In other words, with a certain probability (1−ε) the Agent 805 chooses a greedy action (i.e., an action selected based on the highest Q-value) to perform. With a certain probability [ε*(1−η)] the Agent 805 takes a “virtuous” action, where by “virtuous action” it is not meant a purely random action as in the known F-greedy policy, rather it is an action that satisfies some constraints (in the present exemplary case, the constraint is: selecting, at each step of an Episode, a different Target cell 110 for optimization; however, other types of constraint can be envisaged).

Such an ε-η-greedy collection policy is effective in contexts where the Agent 805 has to learn complex patterns, whose probability of occurring with a purely random policy is very low. The behaviour which the DRL Agent 330 has to learn (in the exemplary case here considered, selecting, at each step of an Episode, a different Target cell 110 for optimization) is not imposed to the DRL Agent 330, rather the DRL Agent 330 learns it by itself as a consequence of the constraints, and in times much shorter than if a purely random exploration policy would be adopted.

In fact, assuming (as it is) that the steps of an Episode are statistically independent from each other, the probability P_{episode,ok} that, by selecting purely random actions to be taken on the simulated network environment 305, the DRL agent 330 chooses, at each step of an Episode, a different Target cell 120 for optimization is:

$${P}_{episode , ok} = P ( {step}_{n , ok} \vert {step}_{n - 1 , ok} , … , {step}_{1 , ok} ) == {\prod }_{i = 0}^{n - 1} ( 1 - i / n ) = ( n - 1 ) ! / {n}^{n - 1}$$

where step_{1,ok} means that, at step 1 of the Episode, the action that the DRL Agent 330 chooses to perform on the simulated network environment 305 concerns a Target cell 120 is selected for optimization that had not been selected before, . . . , step_{n-1,ok} means that, at step (n−1) of the Episode, the action that the DRL Agent 330 chooses to perform concerns a Target cell 120 never selected at previous steps of the Episode, and step_{1,ok} means that, at the last, nth step of the Episode, the action that the DRL Agent 330 chooses to perform concerns a Target cell 120 never selected in all the previous steps of the Episode. P(step_{n,ok}|step_{n-1,ok}, . . . , step_{1,ok}) expresses a conditional probability.

In the exemplary case of 9 possible actions on 9 Target cells 110 (i.e., n=9), the probability of randomly choosing, during an Episode, 9 actions on 9 different cells consecutively is:

$$8 ! / {9}^{8} \approx 0.00093$$

$$and$$

$$1 / ( 8 ! / {9}^{8} ) \approx 1067$$

which means that, on average, the desired behaviour occurs once every 1,067 Episodes. The figure becomes quickly worse and worse (increasing exponentially) as the number n of Target cells increases: for example, if n=13 the desired behaviour occurs once every 48,639 Episodes.

Quite a long time would thus be needed for the Agent to learn to which observed states of the simulated network environment 305 “virtuous” actions are to be associated, should a purely random exploration policy be adopted. In fact, it is not sufficient that the Agent observes the behaviour just once for learning how to respect the constraint. For example, let it be assumed that, at the instant t3 of a generic Episode (i.e., after the first two Episode steps) the state observed by the Agent contains a “1” in the hot-encoding channels corresponding to, e.g., Target cells #2 and #3 of the 9 Target cells 120. If, at instant t3, the Agent selects an action which tries to optimize any one of the two Target cells #2, #3, like an action [tilt 3, cell #2], since those cells have already optimized in the previous two steps of the Episode, the Agent receives a negative reward and a negative Q-value will be associated to the pair (state,action): the Agent will have learnt that if Target cells #2 and #3 have already been optimized, the action [tilt 3, cell #2] is not to be taken (because it produces a negative reward, i.e., a negative Q-value). However, the Agent has not yet learnt that also other actions trying to set different tilts (different from tilt 3) for the Target cells #2 and #3 would return a same, negative reward: to learn this, the Agent would have to collect a certain number of experiences. Moreover, during a subsequent Episode the observed state, at instant t3 of that Episode, could be such that there is a “1” in the hot-encoding channels corresponding to different Target cells 120, e.g., Target cells #5 and #9. The knowledge gained in the previous Episode, expressed by the negative Q-value, is not useful to the Agent for preventing the choice of an action that again violates the constraint, because the state of the Environment is different.

Exhaustively observing every single combination (state,action) is not practical or even impossible, and for this reason DRL is adopted, with neural networks that are used as estimators of the Q-values (differently from classical RL, which is based on tables in which the experiences are collected). Nevertheless, even with DRL the Agent has to collect positive and negative experiences for a certain number of times before actually learning the desired behaviour: if the positive experiences are too rare, the Agent collects almost only negative experiences and is not in condition of learning the desired behaviour in a relatively short time.

The adoption of the ε-η-greedy collection policy mitigates this problem.

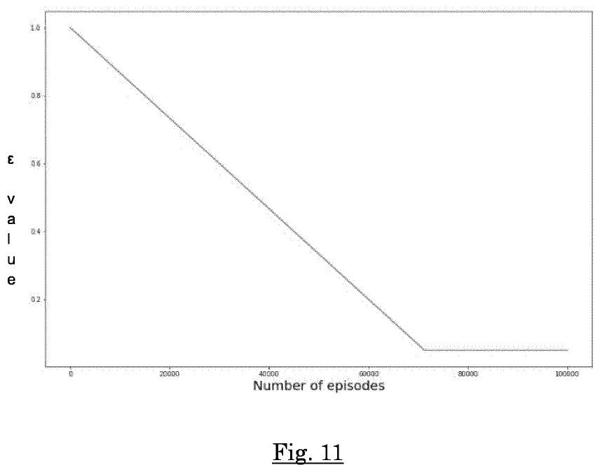

The value of the probability ε can be constant or it can vary as the number of Episodes increases. In particular, the value of the probability ε may decrease as the number of the Episodes increases. For example, during the training phase the value of ε can decrease monotonically, e.g., substantially linearly as exemplified in FIG. 11, from an initial value of (approximately) ε=1 at the beginning to a value of (approximately) ε=0.05 after about 70,000 Episodes (thereafter, the value of ε may remain constant).

The dynamic variation of the value of ε responds to the consideration that the estimated Q-values become more and more accurate as the training proceeds, thereby at the beginning of the training the exploration is favoured, and as the training proceeds, exploitation (of the acquired knowledge of the Q-values) is favoured in visiting the deep MDP tree.

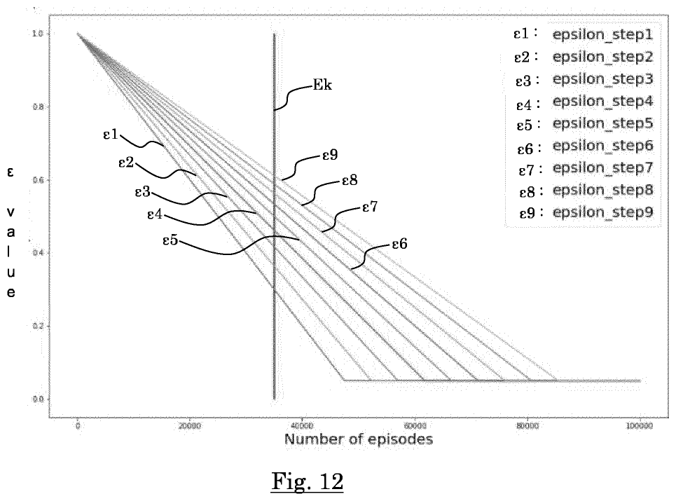

According to an embodiment of the solution disclosed herein, instead of having just one monotonically decreasing probability ε for all the steps of a generic Episode (which means that at a generic time during the training phase a same value of probability ε is used for every step of that Episode, or, otherwise stated, each level of depth of the MDP tree is explored with the same probability), two or more monotonically decreasing probabilities ε are provided, for different steps of a generic Episode. For example, a different monotonically decreasing probability is defined for every step of a generic Episode, as the nine different monotonically decreasing F probabilities ε1, ε2, ε3, ε4, ε5, ε6, ε7, ε8, and ε9 depicted in FIG. 12 which relates to the exemplary case considered herein of nine steps per Episode. For example, the values of all the nine ε probabilities ε1, ε2, ε3, ε4, ε5, ε6, ε7, ε8, and ε9 decrease, with the increase in the number of Episodes, (substantially) linearly from an initial value of (approximately) 1 at the beginning, with a decrease rate (slope) that progressively decreases, from ε1 to ε9. The vertical line Ek denotes the generic k^{th} Episode, and the intersections of the line Ek with the nine lines ε1, ε2, ε3, ε4, ε5, ε6, ε7, ε8, and ε9 gives the values of the probability ε used for the nine steps of that Episode.

In the example shown in FIG. 12, all the nine ε probabilities ε1, ε2, ε3, ε4, ε5, ε6, ε7, ε8, and ε9 starts with a value of 1 and then decrease, with different rates, reaching a value of approximately 0.05 after respective numbers of Episodes.

In this way, during the generic Episode, the MDP tree nodes at the higher (upper) levels are explored for shorter times (thereby the exploitation phase starts earlier), whereas the MDP tree nodes at the lower (bottom) levels are explored for longer times (thereby the exploitation phase begins later).

This responds to the consideration that as the depth of the MDP tree increases, the number of possible tree nodes increases exponentially, and a longer-lasting exploration phase is preferable.

A “sequential” pruning of the MDP tree is achieved, with improvements in convergence time and in quality of the found solutions. As the training proceeds, less deep nodes of the MDP tree start entering in the exploitation phase earlier compared to deeper nodes.

By controlling the value of the parameter η of choosing an action over a limited set (of actions compliant with the constraint), the number of positive experiences and penalties is balanced, and the problem of sparse positive reward is overcome. The F-η-greedy policy does not entirely preclude the Agent from choosing an action that violates a constraint (unless the value of η is set equal to 1). Instead, the Agent might find that violating a constraint provides a better long-term reward despite the immediate negative penalty.

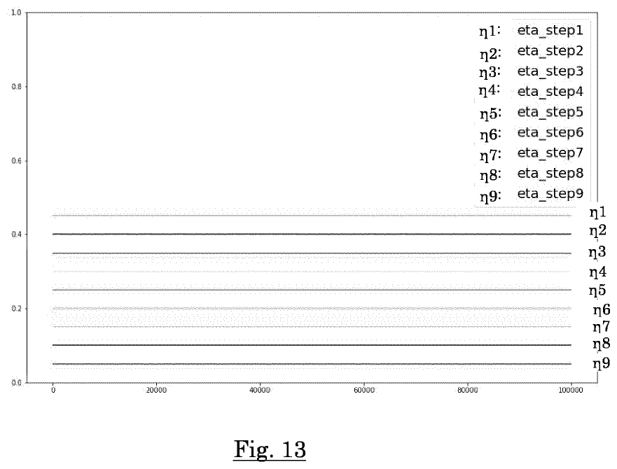

The value of the probability η (which determines the probability (1−η) of performing a “virtuous” action) can be equal for all the steps of an Episode, or it can vary from step to step of an Episode. In particular, as shown in FIG. 13, the value of η may decrease during an Episode, starting from an initial value for the first step of the Episode and decreasing to a final value for the last step of the Episode. In this way, since the probability that the desired behaviour (“virtuous action”) casually occurs as deeper nodes of the IMDP tree are visited (i.e., with the progress of the Episode steps) is (1−η), by decreasing the value of η the “virtuous” behaviour is forced to occur more frequently.

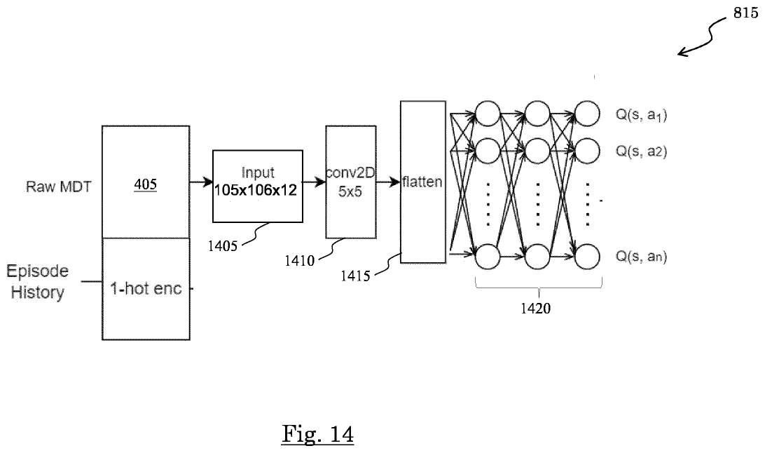

FIG. 14 schematically shows the structure of the DNN 815, in embodiments of the solution disclosed herein.

The matrix 1405 of (p*q) pixels*(n+3) channels (three channels per pixel, representing the values pixel WEIGHT, pixel RSRP, pixel SINR, calculated by the pre-processing module 405 of the simulated network environment 305, plus the Episode history) (105*106*12 channels in the exemplary case here considered) is fed in input to a convolutional layer 1410. The output of the convolutional layer 1410, after flattening (flattening layer 1415), is fed to three fully concatenated layers 1420. The output of the three fully connected layers 1420 are the Q-values Q(s,a₁), Q(s,a₂), . . . Q(s,aₙ) of the 5*9=45 possible actions (5 possible tilts for 9 Target cells).

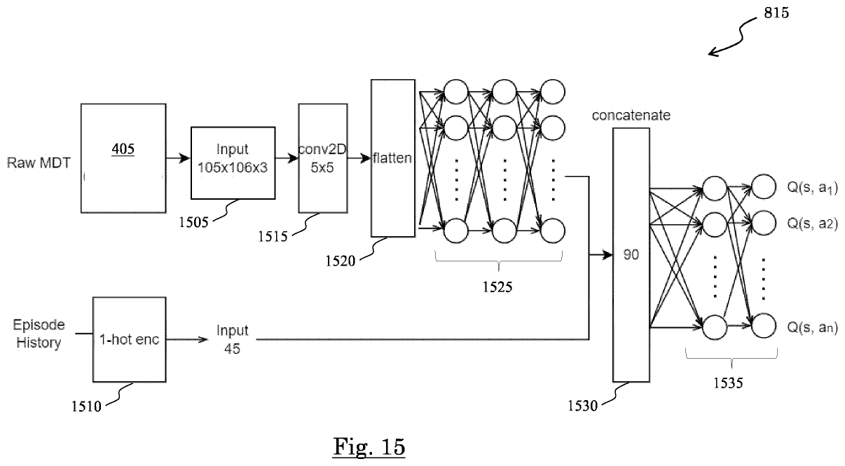

FIG. 15 depicts an alternative structure of the DNN 815, in other embodiments of the solution disclosed herein.

Compared to the embodiment of FIG. 14, the input to the DNN 815 has been modified and split in:
a matrix 1505 of (p*q) pixels (105*106 pixels, in the considered example) with 3 channels for each pixel pxᵢ (pixel RSRP, pixel SINR, pixel weight wᵢ), calculated by the pre-processing module 405 of the simulated network environment 305, and
a number of inputs 1510 equal to the total number of possible actions at every step of an Episode, representing the Episode history (in the considered example of 9 Target cells each having 5 possible tilts, 45 one-hot encoding channels).

Thus, compared to the embodiment of FIG. 14, the differences in the embodiment of FIG. 15 are: a) instead of having, for each of the (9, in the considered example) one-hot encoding channels, a matrix of dimension (p*q) pixels (105*106 in the considered example), every one-hot encoding channel is now composed by just one bit (“1” or “0”), and b) instead of having one one-hot encoding channel for each Target cell 110), the number of inputs has been increased to be equal to the total number of actions that can be taken at each step, so as to represent the Episode history (45 actions, under the assumption that the Target cells 110 are 9, each having 5 possible electrical antenna tilt values), i.e., there is one input per action.

The inputs corresponding to the three channels (RSRP, SINR, WEIGHT) (i.e., the three matrices of dimension (p×q)) are processed by a convolutional layer 1515 and then (after flattening 1520) by a number of (e.g., three) fully connected layers 1525.

The other inputs 1510, representing the Episode history (45 inputs, in the example), are not processed by the convolutional layer 1515 and by the three fully connected layers 1525, being instead concatenated 1530 with the output of the three fully connected layers 1525 and then the concatenated data are processed jointly by a number of (e.g., two) fully connected layers 1535.

The output of the last fully connected layer of the fully connected layers 1535 are the Q-values Q(s,a₁), Q(s,a₂), . . . , Q(s,aₙ) of the (45, in the considered example) possible actions, which Q-values control the selection of an action by the Agent according to the ε-η-greedy policy.

Tests conducted by the Applicant have shown that quite significant improvements are achieved in the training phase of the DRL Agent 330 compared to a classical F-greedy collection policy, both under the viewpoint of the times for converging towards a good solution, under the viewpoint of training stability and under the viewpoint of the goodness of the found solution.

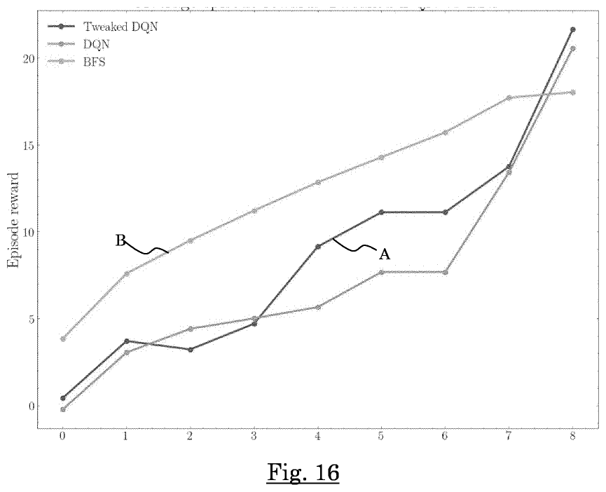

FIG. 16 is a diagram (with number of Episode steps in abscissa and Reward in ordinate) showing that the DRL agent 330 with the ε-η-greedy policy, curve A in the diagram, is able to overtake the performance of a tree search baseline algorithm like a Best First Search—BFS, curve B in the diagram. It can be appreciated that the DRL agent 330 with the ε-η-greedy policy learns to “sacrifice” the immediate reward in favour of the cumulative Episode reward.

The solution disclosed in this document can implemented with a single DRL Agent or with multiple DRL Agents, for fully distributed/hybrid solutions for larger or denser geographical areas.

As mentioned in the foregoing, SON envisages three kinds of architectures: centralized, hybrid, distributed. A centralized solution may be preferred for optimality and stationarity, whereas a distributed solution is preferable as far as scalability issued are concerned. The best tradeoff approach for larger cities or denser urban areas might envision a hybrid solution where multiple DRL Agents in accordance with the present disclosure are responsible for variable-sized adjacent clusters instead of single e/gNodeBs. These hybrid solutions might envision DRL Agents configured to learn cooperatively to maximize a common reward based on their mild-to-severe mutual interference, which is statistically measurable through MDT data analysis.

1. A method, implemented by a data processing system, of adjusting modifiable parameters of network cells of a deployed self-organizing cellular mobile communications network comprising network cells covering a geographic area of interest, said network cells comprising configurable cells having modifiable parameters, and non-configurable cells in the neighborhood of the configurable cells, the method comprising:
providing an Environment configured for simulating said mobile communications network, wherein the Environment is configured to simulate said mobile communications network based upon:
radio measurement data, comprising radio measurements with associated geolocalization and time stamp, performed by user equipment connected to the mobile communications network and received from the deployed mobile communications network;
network performance data provided by the deployed mobile communications network, and
simulation data obtained by an electromagnetic field propagation simulator and corresponding to different possible configurations of the values of the modifiable parameters of the configurable cells;
providing a DRL Agent configured for interacting with the Environment by acting on the Environment to cause the Environment to simulate effects, in terms of network performance, of modifications of the values of the modifiable parameters of the configurable cells, the Environment being configured for calculating and returning to the DRL Agent a Reward indicative of the goodness of the actions selected by the DRL Agent and undertaken on the Environment, the Reward being exploited by the DRL Agent for training and estimating Q-values,
wherein:
the DRL Agent, during training time, in selecting an action to be undertaken on the Environment among all the possible actions, adopts an action selection policy that:
with a certain first probability selects a greedy action based on the estimated Q-values,
with a second probability selects:
either a random action selected randomly among all the possible actions, with a third probability, or
with a fourth probability, a random action among a set of actions that satisfy a predetermined action constraint,
wherein
in case the DRL Agent selects, and causes the Environment to simulate the effects of, an action that violates said predetermined constraint, the Environment is configured to return to the DRL Agent a penalizing Reward.

2. The method of claim 1, wherein said radio measurement data comprising radio measurements with associated geolocalization and time stamp are Minimization of Drive Test, MDT, data.

3. The method of claim 1, wherein said predetermined action constraint is a constraint for not attempting to modify a modifiable parameter of a configurable cell already subjected, in past actions selected by the DRL Agent, to a modification of its modifiable parameters.

4. The method of claim 1, wherein:
the sum of said first and second probabilities is 1, and
the sum of said third and fourth probabilities is 1.

5. The method of claim 1, wherein:
each action selected by the DRL Agent is an action that attempts to modify the value of one single configurable parameter of one single configurable cell of the configurable cells.

6. The method of claim 1, wherein:
the Environment is configured to command the DRL Agent to stop an ongoing sequence of actions after a predetermined number of actions selected by the DRL Agent that violates said predetermined constraint.

7. The method of claim 1, wherein the Environment is configured for analyzing and aggregating said radio measurement data comprising radio measurements with associated geolocalization and time stamp, based on geolocation information included in the radio measurement data, in territory pixels corresponding to the territory pixels of the simulation data.

8. The method of claim 7, wherein the Environment is configured for calculating, for each territory pixel and based on the MDT data:
a pixel RSRP being an average of the RSRPs included in the MDT data corresponding to such pixel;
a pixel SINR, and
a pixel weight providing an indication of an average number of active UEs or RRC connected UEs, in such pixel.

9. The method of claim 8, wherein the Environment is configured to calculate, for every pixel:
a RSRP difference between the calculated pixel RSRP, calculated based on the MDT data, and the RSRP resulting from the simulation data, and
a SINR difference between the calculated pixel SINR, calculated based on the MDT data, and the SINR resulting from the simulation data.

10. The method of claim 9, wherein the Environment, when the DRL Agent undertakes an action on it, is configured to, for every pixel:
taking the RSRP and the SINR from the simulation data that correspond to the new configuration of the configurable cells indicated in the actions requested by the DRL Agent, and
applying to the RSRP and SINR taken from the simulation data said RSRP difference and said SINR difference, respectively, to obtain estimated RSRP and estimated SINR for the new configuration of the configurable cells.

11. The method of claim 10, wherein the Environment is configured to:
re-assigning territory pixels to respective best-server network cells based on the estimated RSRP for the new configuration of the configurable cells.

12. The method of claim 11, wherein the Environment is configured to:
redistribute UEs to the network cells based on the re-assignment of the territory pixels to the respective best-server network cells, and
calculate numbers of UEs per network cell for the new configuration.

13. The method of claim 12, wherein said Reward indicative of the goodness of the actions selected by the DRL Agent is indicative of an estimated overall performance of a network configuration resulting from a simulation of modifications of the values of the modifiable parameters of the configurable network cells by the Environment, wherein the Environment is configured to calculate said Reward by calculating an estimation of an overall throughput as a weighted average of estimated average user throughputs per network cell, where the weights in the weighted average are based on said calculated numbers of UEs per network cell.

14. A data processing system configured for automatically adjusting modifiable parameters of network cells of a self-organizing cellular mobile communications network, the system comprising:
a self-organizing network module comprising a capacity and coverage optimization module,
wherein the capacity and coverage optimization module is configured to execute the method of claim 1.
